(19) United States
(12) Patent Application Publication
(10) Pub. No.: US 2009/0204610 A1
(43) Pub. Date: Aug. 13, 2009

(54) DEEP WEB MINER

(76) Inventors: Benjamin J. Hellstrom, Ellicott City, MD (US); Joseph C. Roden, Bel Air, MD (US)

Correspondence Address: STEVENS & SHOWALTER, L.L.P., BOX BAT, 7019 CORPORATE WAY, DAYTON, OH, 45459-4238, US

(21) Appl. No.: 12/369,488

(22) Filed: Feb. 11, 2009

Related U.S. Application Data
(60) Provisional application No. 61/027,718, filed on Feb. 11, 2008.

(51) Int. Cl. G06F 17/30

(52) U.S. Cl. 707/5; 703/13; 707/E17.108; 707/E17.109; 715/222

(57) ABSTRACT

Systems, computer implemented methods and computer program products are provided for selectively capturing and/or evaluating information including content and metadata from across a network such as the “wide world web” (WWW), or more generally, the Internet. A deep web mining tool may be utilized to exploit the deep web by understanding forms, search engines and results pages. Moreover, deep web mining tool may be utilized to extract and exploit structured and unstructured content and metadata from web sites and documents, generate queries, capture and re-link web sites, crawl through web sites and non-HTML files and perform other aspects of obtaining and/or evaluating information.

### CROSS REFERENCE TO RELATED APPLICATIONS

This application claims the benefit of U.S. Provisional Patent Application Ser. No. 61/027,718 filed Feb. 11, 2008 entitled “Deep Web Miner”, the disclosure of which is hereby incorporated by reference.

### BACKGROUND OF THE INVENTION

The present invention relates to tools for selectively capturing network accessible information including content and metadata.

The Internet, including the World Wide Web, is a source of vast quantities of data. In this regard, traditional search engines attempt to locate and index this data in order to respond with relevant results to user-initiated queries. However, conventional search engines are extremely limited in their results. For example, the content on the Internet may be characterized as “surface web” content, which traditional search engines can index, and “deep web” content, which search engines typically cannot index.

Deep web content includes for example, information in private databases, information that is retrievable only as a result of a executing a query or processing an on-line form, unlinked content, information stored in private or otherwise secure network locations, scripted content, non-hypertext markup language (HTML) files such as images, video, audio, Portable Document Format (PDF) files, executable files and other types of content that are not otherwise accessible to be crawled by conventional search engines.

Moreover, it is estimated that the deep web comprises a significant portion of the content associated with the Internet. Accordingly, it is likely that a substantial amount of information that may be relevant to a query topic is inaccessible to traditional search engines as they typically do not crawl or otherwise index the deep web.

### BRIEF SUMMARY OF THE INVENTION

According to aspects of the present invention, systems, methods and computer program products are provided for extracting information from a network by obtaining seed information from a user and by identifying a search engine to utilize for performing deep web mining. The seed information provided by the user is mapped to query terms suitable for use with the identified search engine. Once the query terms have been mapped, an iterative mining process is performed by retrieving a query page having a form for accessing the search engine and by simulating entry of the form to automatically submit a query to the search engine based at least in part, upon the derived query terms.

Addresses of interest are identified from the query results and the network is crawled to obtain content and/or metadata from the identified addresses of interest. Moreover, a local, navigable copy of the content obtained from crawling the network may be build at a local storage device. Still further, the resulting content returned from the crawlers is analyzed to generate new content based query terms, which are used to submit new queries to the search engine as part of the iterative process.

According to further aspects of the present invention, a computer program product is provided for performing deep web mining operations. The computer program product includes a computer usable medium having computer usable program code embodied therewith. The computer usable program code comprising computer usable program code configured to define a new task corresponding to a concept space associated with a topic of interest to a user. The computer usable program code also comprises computer usable program code configured to obtain seed information with regard to the concept space including identifying at least one of an on-line form and at least one search term.

Still further, the computer program product comprises computer usable program code configured to create at least one deep mining thread associated with the defined new task, wherein the deep web mining thread performs a mining process. To implement the mining process, the computer program product comprises computer usable program code configured to define a plurality of content-service threads and crawler threads. Computer usable program code is also configured to generate at least one query derived from keyword information within the corresponding task and/or terms obtained from analysis of crawled content and computer usable program code configured to queue the generated queries.

To implement the mining process, the computer program product further comprises computer usable program code configured to declare a specific implementation of an abstract forms-based query service in a corresponding content-service thread that executes a deep mining process by matching an identified on-line form to a corresponding form-understanding plug-in that understands the format of the on-line form, wherein the selected form-understanding plug-in simulates the submission of a query and identifies relevant result addresses.

The mining process is further implemented by computer usable program code configured to queue query result addresses in a crawler queue, computer usable program code configured to asynchronously service each result address by a corresponding crawler thread that obtains content and/or metadata that is cached in a local storage medium and computer usable program code configured to process the content of the returned results. Still further, computer usable program code is configured to update a display with a listing of the mined results, wherein the user may browse a local navigable copy of the crawled results in isolation by selecting a navigable entry of the listing.

The computer program product may also optionally include computer usable program code that enables a user to build a form-understanding plug-in that is usable by the computer usable program code configured to declare a specific implementation of an abstract forms-based query service in a corresponding content-service thread. In this regard, the computer program product may further comprise computer usable program code configured to obtain a web site of interest, computer usable program code configured to retrieve a query page having a form for accessing the site's search engine, computer usable program code configured to recognize or obtain relevant form input(s), and computer usable program code configured to generate or obtain example search term(s).

The computer usable program code that enables a user to build a form-understanding plug-in further comprises computer usable program code configured to simulate entry of the form to submit a query to the search engine based on the example query term(s) and computer usable program code configured to receive query results returned in response to submitting the query form to the search engine, the query results comprising at least one page of addresses to locations on the network having content responsive to the submitted query.

The computer usable program code that enables a user to build a form-understanding plug-in further comprises computer usable program code configured to recognize or obtain result anchors of interest within the query results, computer usable program code configured to derive a pattern that distinguishes result anchors from non-result anchors, computer usable program code configured to recognize or obtain next page anchors of interest within the query results, computer usable program code configured to derive a pattern that distinguishes next page anchors from other anchors and computer usable program code configured for persisting the resulting form-understanding plug-in for subsequent use by the deep web miner.

According to further aspects of the present invention, a method of extracting information from a network comprises executing a user interface on a computer for obtaining seed information from a user, where the seed information provides sufficient information to define a concept of interest to the user, identifying a search engine to utilize for performing deep web mining, mapping the seed information provided by the user to query terms suitable for use with the identified search engine and performing an iterative mining process until a stopping event is detected.

The iterative mining process may be performed by retrieving a query page having a form for accessing the search engine, simulating entry of the form to submit a query to the search engine based at least in part upon the derived query terms and receiving query results returned in response to submitting the query form to the search engine, the query results comprising at least one page of addresses to locations on the network having content responsive to the submitted query and identifying addresses of interest from the query results for further processing.

The iterative mining process may further be performed by crawling the network to obtain content from the identified addresses of interest and building a local navigable copy of the content obtained from crawling the network in a local storage device. In this regard, links within the content of the local navigable copy may be limited to the local copy itself and may not function if the link contents were not captured by the corresponding mining process.

The iterative mining process may further be performed by analyzing the resulting content returned from crawling the network, generating at least one new content based query term based upon analyzing the search results, updating the query terms based upon at least one new content-based query term, dynamically conveying the results of processing to the user such that the user can interact with a dynamically changing local navigable environment while the mining process is iterating and dynamically reconfiguring the iterative mining process based upon user interaction, while the mining process is iterating.

### BRIEF DESCRIPTION OF THE SEVERAL VIEWS OF THE DRAWINGS

The following detailed description of various aspects of the present invention can be best understood when read in conjunction with the following drawings, where like structure is indicated with like reference numerals, and in which:

FIG. 1 is a block diagram of a system including a deep web miner for capturing network accessible content and metadata according to various aspects of the present invention;

FIG. 2 is an illustration showing the deep web miner of FIG. 1 interacting with both the surface web and deep web aspects of the Internet according to various aspects of the present invention;

FIG. 3 is a flowchart illustrating a deep web mining process according to various aspects of the present invention;

FIG. 4 is a block diagram of an implementation of the deep web miner according to various aspects of the present invention;

FIG. 5 is a block diagram of nested operations performed by the deep web miner according to various aspects of the present invention;

FIG. 6-14 are screen shots of an illustrative user interface screens for initiating a deep web mining process according to various aspects of the present invention;

FIG. 15 is an illustration of an exemplary search engine form accessed by a form-understanding plug-in of the deep web miner according to various aspects of the present invention;

FIG. 16 is an illustration of the deep web miner automatically filling out the exemplary search engine form of FIG. 15 based upon a user initiated search criteria, according to various aspects of the present invention;

FIG. 17 is an illustration of an exemplary search engine results page returned to the deep web miner in response to the search of FIG. 16;

FIGS. 18A and 18B are block diagrams of select components defining an implementation of a deep web miner according to various aspects of the present invention;

FIG. 19 is a table illustrating exemplary processors the deep web miner may implement according to various aspects of the present invention;

FIG. 20A is a graph showing information about possible query results from a single search term;

FIG. 20B is a graph showing information about possible query results from a paired query;

FIG. 20C is a graph showing information about possible query results from a chained query;

FIG. 21 is a block diagram of a component for training and/or building a form-understanding plug-in according to various aspects of the present invention;

FIG. 22 is a screen shot illustrating an exemplary implementation of the component of FIG. 21, according to various aspects of the present invention; and

FIG. 23 is a block diagram of an exemplary computer system including a computer usable medium having computer usable program code embodied therewith, where the exemplary computer system is capable of executing a computer program product to provide deep web mining according to various aspects of the present invention.

### DETAILED DESCRIPTION OF THE INVENTION

According to various aspects of the present invention, systems, computer implemented methods and computer program products are provided for selectively capturing and/or evaluating information including content and metadata from across a network such as the “wide world web” (WWW), or more generally, the Internet.

As will be described more fully herein, a deep web mining tool may be utilized to exploit the deep web by understanding forms, search engines and results pages. Moreover, the deep web mining tool may be utilized to extract and exploit structured and unstructured content and metadata from web sites and documents, generate queries, capture and re-link web sites, crawl through web sites and non-HTML files and perform other aspects of obtaining and/or evaluating information. The deep web mining tool may be further utilized to output HTML files and supporting media, such as PDF files, text files, images, style sheets, scripts, movies, audio files, etc., to create a local navigable copy of mined content as will be described in greater detail herein. Moreover, the deep web mining tool may be utilized to output Extensible Markup Language (XML) containing metadata such as Uniform Resource Locators (URLs), text content and query terms used for mining processes, etc.

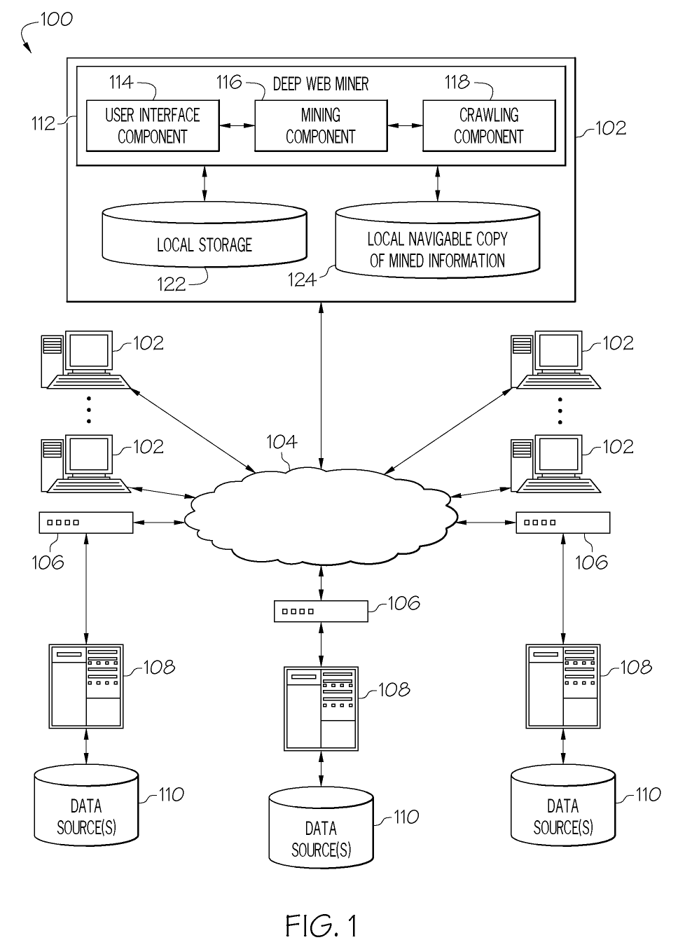

Referring now to the drawings and particularly to FIG. 1, a general diagram of a computer system 100 is illustrated. The computer system 100 comprises a plurality hardware and/or software processing devices, designated generally by the reference 102 that are linked together by a network 104. Typical processing devices 102 may include personal computers, notebook computers, transactional systems, purpose-driven appliances, pervasive computing devices such as a personal data assistant (PDA), palm computers, cellular access processing devices, special purpose computing devices and/or other devices capable of communicating over the network 104.

The network 104 provides communications links between the various processing devices 102, and may be supported by networking components 106 that interconnect the processing devices 102, including for example, routers, hubs, firewalls, network interfaces wired or wireless communications devices and corresponding interconnections. Moreover, the network 104 may comprise connections using one or more intranets, extranets, local area networks (LAN), wide area networks (WAN), wireless networks (e.g. WIFI, WiMAX), the Internet, including the World Wide Web (WWW), and/or other arrangements for enabling communication between the processing devices 102.

The illustrative system 100 also includes a plurality of processing devices 108, e.g., servers, dedicated networked storage devices and other processing devices that store information in data sources 110. The information stored in the data source(s) 110 may include content utilized to generate HTML pages, structured and unstructured documents, media including images, audio files and/or video files, Flash or other executable program(s), metadata, etc. The system 100 is shown by way of illustration, and not by way of limitation, as a computing environment in which various aspects of the present invention may be practiced.

Conventional web browsers may be executed on the various processing devices 102 to retrieve content from the network 104 by identifying a unique URL that serves as the address for the associated content. For example, the content may be data such as a web page, document, media file, etc., that is maintained within the data source 110 of a corresponding one of the processing devices 108. The web browsers may then update page layouts while asynchronously retrieving additional content and/or performing other similar tasks. The web browsers may also be required to execute scripts or other designated executable code as part of web browsing operations. For example, a web page may utilize a script to interact with one or more servers, pull additional content, and modify itself dynamically. Eventually, a corresponding “web page” is assembled within the corresponding browser.

For purposes of clarity of discussion herein, the term “web page” or simply “page” is used to refer to content that is retrieved, laid out and displayed in one or more browser windows in response to a single request for content. For example, a web page may be generated from a hypertext markup language (HTML) document, a collection of documents, media, executable code, etc. In this regard, a web page may not consist of HTML at all. If a browser executes a script that retrieves additional content within a predetermined time period (Δt), then that retrieved content may be considered part of the web page. However, if the browser executes a script that delays for longer than the predetermined time period (Δt) before returning the content, then such content is not considered as part of the requested web page.

Moreover, a given “web page” may be a static page such that each visit to that static page returns the same content. Correspondingly, a given web page may be a dynamic page such that each visit to a specific URL may return different content. Thus, if the user requests the same URL again, the browser fetches a new “page”. The content and appearance may be the same as or different from that of the previous URL request, but it is still a new “page”.

As an illustrative example, a user may enter a desired URL into an “address” bar of a web browser executing on a select one of the processing devices 102. The user may alternatively click on a link, select a “favorite”, or utilize any other method supported by the associated web browser for designating the desired URL. The web browser builds and dispatches the request, synchronously retrieves the web page associated with the designated URL, and then asynchronously retrieves all supporting HTML pages and/or other content.

The Deep Web Miner:

According to various aspects of the present invention, a desktop software application referred to herein as a deep web miner 112 defines a tool that is executed on a corresponding one of the processing devices 102 to capture and/or evaluate information including content and metadata that may be located anywhere across the computer system 100.

According to aspects of the present invention, the deep web miner 112 includes a user interface component, 114, a mining component 116 and a crawling component 118, which are collectively utilized to mine, crawl and/or otherwise evaluate information obtained from the network 104 as set out more fully herein. For example, the mining component 116 may utilize seed information provided by a user via the interface component 114 to derive query terms or other types of search parameters, perform iterative mining processes (focused data collection) and dynamically convey results to the user. In this regard, mining may be performed by simulating the entry of forms to submit queries to one or more search engines based at least in part, upon the derived query terms. As will be described in greater detail herein, the deep web miner 112 may match an identified on-line form to a corresponding “form-understanding plug-in” that understands the format of the on-line form such that the selected form-understanding plug-in simulates the submission of a query and identifies relevant result addresses. The crawling component 118 may correspondingly analyze the results returned from the iterative mining process, e.g., to collect content as will be described in greater detail herein.

Information that is retrieved from the network 104 may be stored in a local storage 122. Also, according to various aspects of the present invention, the deep web miner 112 may build a local navigable copy 124 of mined information retrieved from the network 104, e.g., for analysis by analytical tools. Although illustrated separately for purposes of discussion, the navigable copy 124 may be stored within the local storage 122 or in other practical locations, e.g., on a storage drive associated with the processing device 102, etc. As will be described in greater detail below, a user may interact with the user interface component 114 to configure the deep web miner 112 to broadly mine information or to retrieve a tightly focused collection of strictly relevant documents.

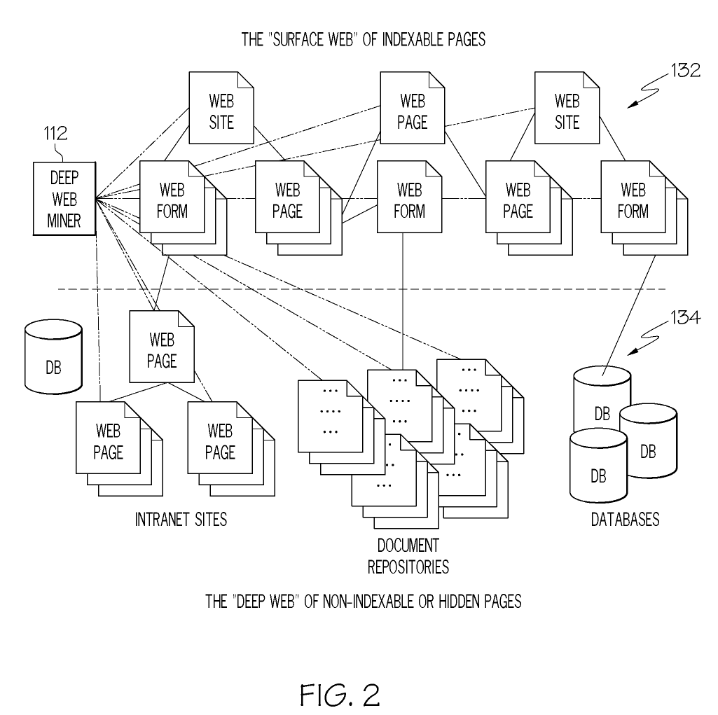

Referring to FIG. 2, the deep web miner 112 is capable of interacting with a “surface web” portion 132 of the Internet as well as a “deep web” portion 134 of the Internet. The surface web portion 132 comprises web sites and web pages that are readily accessible, and which are typically locatable using conventional search engines and/or by providing URL addresses into a navigation control of a conventional web browser as described above. Moreover, the deep web portion 134 comprises content that may be located on intranet sites, private or otherwise secure network locations, document repositories, private databases and other locations typically not crawled by conventional search engines, such as locations that are accessed as a result of a executing a query or processing an on-line form. Additionally, deep web content may include unlinked content, script and other executable files, non-hypertext markup language (HTML) files such as images, video, audio, PDF files and other types of content that are not otherwise accessible to be crawled by conventional search engines. Such sources of information are not indexed by traditional search engines and are considered the “deep web” because they are generally hidden from the perspective of a searcher using a conventional search engine.

As will be described in greater detail herein, the deep web miner 112 may automatically enter data into forms and submit form-based requests for information across the network 104. As an illustration, the deep web miner 112 may interact with online forms that follow a common “search engine” pattern. However, the number and types of forms found on the Internet are theoretically limitless. For example, forms may be used to collect usernames and passwords for authentication, collect credit or financial information, support information search and retrieval and perform countless other functions. Depending upon the particular implementation, forms may use recognizable “customary” graphic elements such as text boxes and submit buttons, or they may use non-standard or non-intuitive graphic elements, icons, symbols or other representations. Moreover, form labeling and input may be displayed and accepted in arbitrary languages. Additionally, the positioning of labeling associated with fields within forms may reside in various proximate locations relative to the form field entry point. Still further, some forms, such as international dictionaries or language translation services, accept multiple language input.

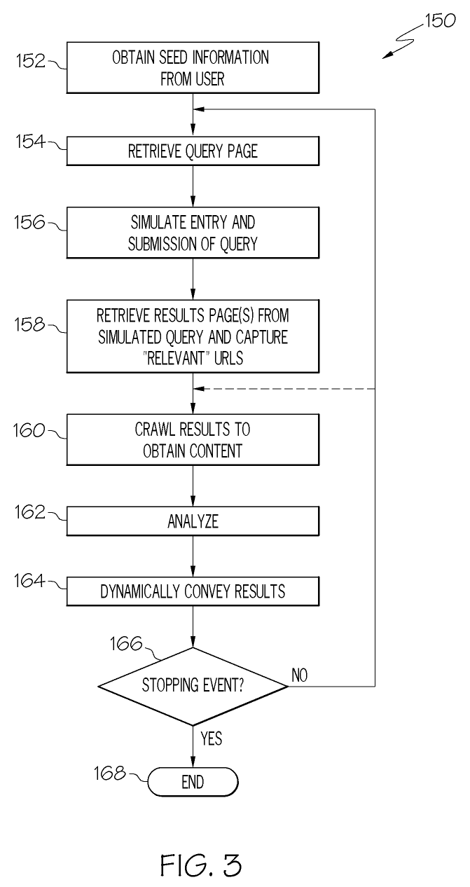

Referring to FIG. 3, a method 150 of implementing deep web mining according to aspects of the present invention is illustrated. Seed information is obtained from a user at 152 where the seed information provides sufficient information to define a concept of interest to the user. In this regard, the seed information may specify or otherwise define a “concept space” that will affect a corresponding mining process. For example, a user may provide the deep web miner 112 with seed information by specifying a starting URL, topic(s) of interest, one or more query terms pertaining to the concept of interest, keywords or other significant parameters, etc., before the deep web miner 112 submits requests for information using on-line forms, e.g., to issue a query to a search engine. As will be described in greater detail below, an exemplary approach to obtaining seed information is to provide an abstract search form that is filled out by the user interacting with the user interface component 114 of the deep web miner 112.

The deep web miner 112 identifies a search engine to utilize for performing a mining operation with regard to the concept space derived by the user. For example, the search engine may be selected based upon a starting URL specified with the seed information provided by the user. The search engine may alternatively be selected based upon other factors, e.g., using defaults or otherwise derived criteria. The deep web miner may also map provided seed information to corresponding query terms/search parameters suitable for use with the identified search engine. The deep web miner 112 then retrieves a “query page” of a search engine provided for searching the Internet at 154. The deep web miner then simulates the entry and submission of a query into the query page at 156. The submitted query may utilize one or more of the query terms/search parameters derived from the seed information provided by the user. As will be described in greater detail herein, submission of a query may also be based upon parameters derived from an analysis of previous search results.

According to various aspects of the present invention, the deep web miner 112 utilizes a custom “form-understanding” plug-in to fill out a corresponding on-line form and process the results returned from an issued query to that corresponding on-line form. In this regard, each unique form found on the Internet may utilize a corresponding unique form-understanding plug-in where each plug-in understands the form that it is designed to automatically fill in and submit. Alternatively, a form-understanding plug-in may be generic to one or more forms, as will be described in greater detail herein. Also, one or more plug-ins may be customizable, e.g., by a user or other third party so as to define the parameters that are needed by the deep web miner 112 in order to issue queries to and process results from arbitrary forms or predetermined types of forms. Still further, an extensible plug-in architecture may be utilized such that users and/or developers can expand or add to the capabilities of the plug-ins, such as by providing the capability to add new plug-ins, modify existing plug-ins, delete obsolete plug-ins, etc. Further, although described with reference to plug-ins for convenience of illustration, other approaches may be utilized to convey query terms/search parameters to forms including search engines, etc.

To simulate entry and submission of the query, the deep web miner 112 may thus utilize an appropriate form-understanding plug-in to perform the above-described mapping from abstract search form provided by the user, e.g., the seed information, to query terms/search parameters formatted to the online form of the specific search engine that the plug-in services. For example, the seed information or otherwise previously determined search terms may not be in a format that is directly compatible with a corresponding form or query syntax. However, the seed information may be converted to properly formatted query terms/search parameters that are further mapped to the appropriate fields of the form to implement a search.

The deep web miner then retrieves the “results” page(s) returned from simulating a query and identifies “relevant” result URL(s) from the page for subsequent processing at 158. In this regard, the selected form-understanding plug in may know how to properly format query terms/search parameters and map them to appropriate fields, submit the query, and extract relevant result URLs from non-result, site specific and other information. For example, the selected plug-in may recognize that banners, advertisements and other information in the returned web page are not search result anchors and are thus not relevant. If more that one result page is available, the deep web miner can obtain additional results pages, such as by simulating the selection of a “next” results control or by utilizing other tools provided on the search results page or by the search engine for navigating results.

As will be described in greater detail herein, according to various aspects of the present invention, the deep web miner uses the plug-ins to retrieve URLs from web page search engines/on-line forms. In this regard, depending upon the on-line form, the user may have no control over what links a search engine will respond with in regard to a corresponding query. For example, public search engines each index and organize their data differently. However, regardless of the manner in which a particular search engine generates its response URLs, the appropriate form-understanding plug-in obtains relevant results and hand this information over to crawlers that return the content at the retrieved URLs. The information returned by the crawlers is then analyzed to generate statistics, which are used to issue subsequent queries. Thus, an iterative process is utilized where new queries are generated based upon crawler generated data. Moreover, statistics may be utilized to decide what pages are worth pursuing and which are not.

For example, as will be described in greater detail herein, a user may set breadth or depth limits on the deep web miner 112. However, such constraints may be automatically overridden, such as where the system determines that additional pages (breadth or depth) are relevant to the concept space of the user.

The deep web miner 112 then crawls the results to obtain one or more hyperlinked web pages, associated content and/or metadata at 160, which may include structured and/or unstructured documents, files, media, etc. The crawled results may also include, for example, HTTP transactional metadata that is usually hidden by browsers. For instance, based on captured HTTP transactional data, the deep web miner 112 may determine what type and version of HTTP server was used, or when an image was last updated.

There are many possible strategies for capturing online data from a search engine. If the search engine services a domain with a small, limited number of pages, the user may wish to capture every possible page that could be returned by the search engine. That is, the user may not care to narrow the search with topics. Alternatively, the user will probably want to limit the search if the search engine services thousands or millions of domains. Accordingly, the user interface component 114 of the deep web miner 112 may allow the user to specify information related to content retrieval, e.g., by specifying the maximum number of query results that are captured, the maximum hyperlink depth to crawl, etc.

As a few illustrative examples, the user may want the deep web miner 112 to collect the result page that is identified by each query result URL, and nothing more. Alternatively, the user may wish to collect each result page and then explore the pages that are hyperlinked-to by the result page. As such, the deep web miner 112 may support link exploration. The deep web miner 112 may provide one or more options for controlling link exploration. For example, link exploration can be constrained by total number of links, link depth, URL domain, relevance of page content, etc. In this regard, by limiting the number of result pages that are captured, and by controlling subsequent link exploration, the user may define a custom strategy for capturing content.

The deep web mining process may be performed in an iterative manner. That is, the deep web miner can analyze the returned results at 162, such as to derive new query terms/search parameters. These new terms can be utilized to continue to submit new queries and analyze the results there from. Based upon the analysis of the search results, new content-based query terms may be generated. The optional generation of new content-based query terms may comprise adding new terms, modifying existing terms, deleting existing terms etc., if desired by the specific implementation and if possible, e.g., based upon the nature of the returned results. If new terms are generated, those new terms may be used to update the query terms/search parameters for continued iterative processing, e.g., by looping back to 154.

Moreover, the results obtained by deep web mining processes may be dynamically conveyed at 164. For example, the conveyance may comprise building a dynamically changing local copy of the mined data and/or corresponding metadata. By dynamically updating the results of the mining process, e.g., as the information is captured, the user can thus interact with the results for exploration and analysis, even while the mining process continues to iterate, i.e., before the search process itself is complete. In this regard, the local navigable copy may be limited to the extent that links within the navigable copy to network resources that are on the network outside the local navigable copy itself may not function properly. That is, the extent of the navigable copy may be limited to the scope of received search results.

The conveyance may also comprise providing feedback of the search process to the user, such as by updating information on a display device that interacts with the user interface component 114. Various aspects of the method 150 are described in greater detail herein.

A determination is made at 166 as to whether a stopping event has been detected. As will be described in greater detail herein, the stopping event may include a user imposed link exploration restraint based upon a total number of links, a link depth, a relevance of search results, etc. Moreover, user defined depth constraints may be overridden if query constraints are satisfied in certain implementations.

Thus, the deep web miner may continue to collect results URLs and/or crawl corresponding results until a stopping event is detected. A stopping event may include detecting that no more URLs are available, detecting a command to stop the deep web miner, detecting a command to issue a new query, etc. If no stopping event is detected, then processing continues as described more fully herein. If a stopping event is detected, then the process is ended at 168.

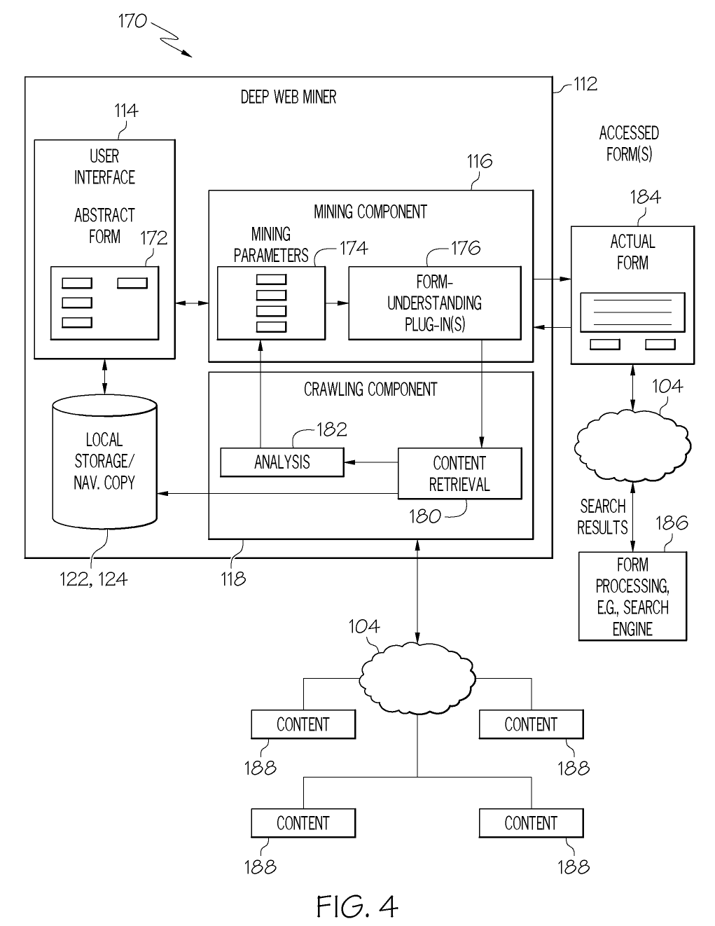

Referring to FIG. 4, a system diagram illustrates an exemplary logical implementation 170 of the deep web miner 112 and its interaction across a network according to various aspects of the present invention. The system diagram may be utilized, for example, to implement the method described with reference to FIG. 3. As noted above, the illustrated deep web miner 112 includes a user interface component 114, a mining component 116 and a crawling component 118.

The user interface component 114 provides a graphic user interface that allows the user to interact with the deep web miner 112, such as for entering seed information, monitoring and/or directing the mining/data retrieval process, for interacting with the results and/or for performing any other processes or functions implemented by the deep web miner 112. For example, the user may interact with an abstract form 172 to provide information that is utilized to initiate a deep mining operation. Also, the user may utilize additional software tools such as analytical applications, visualization applications, web browsing applications, etc., to dynamically interact with the results in addition to or alternatively to the user interface component 114 of the deep web miner 112. Exemplary screen shots of the user interface are described more fully herein.

The mining component 116 further comprises a mining parameters component 174 and a plug-in component 176. In practice, the mining parameters component 174 may be integrated into the plug-in component 176. The mining parameters component 174 organizes the search terms that may be utilized to fill in fields of on-line forms. The plug-in component 176 comprises one or more “form-understanding plug-ins” as described with reference to FIG. 3, where each plug-in is configured to understand one or more on-line forms. In this regard, a selected plug-in from the plug-in component 176 maps the appropriate query terms/search parameters from the mining parameters component 174 to the corresponding on-line form that the particular plug-in services, as described more fully herein.

The illustrated crawling component 118 includes a content retrieval component 180 and an analysis component 182. The content retrieval component 180 obtains data from the Internet based upon the relevant result URLs identified by the plug-in component 176. The content gathered by the content retrieval component 180 is stored in the local storage 122 as will be described more fully herein. The analysis component 182 may analyze the gathered content, such as to generate, modify and revise the query terms/search parameters maintained by the mining parameters component 174.

In operation, the user utilizes the user interface component 114 to provide seed information, e.g., using an abstract form 172. Based upon the seed information, the mining component 116 selects the corresponding form-understanding plug-in and retrieves the query page of the selected on-line form 184. The form-understanding plug-in then simulates the entry and submission of a query in the actual form 184, e.g., based upon one or more of the parameters stored in the mining parameters component 174 by mapping the derived query terms/search parameters to the online form to make forms-based requests for information. The query entered into the query page of the actual on-line form is submitted to a form processing device 186, such as a search engine, and the results thereof are communicated back to the deep web miner 112.

The deep web miner 112 may obtain content for all result URLs returned by the form processing device 186 that are recognized by the selected form-understanding plug-in. Alternatively, the deep web miner 112 may constrain the number of result URLs for which content is gathered, e.g., based upon user defined preferences that are established using the user interface component 114. For example, as noted above, the search engine may service thousands or millions of domains. As such, the user interface component 114 of the deep web miner 112 may allow the user to specify the maximum number of query results that are captured.

The result URLs are passed to the content retrieval component 180, which obtains their corresponding content and optionally extracts hyperlink URLs therein to gather additional content 188, a process commonly referred to as “crawling”. In this regard, the deep web miner 112 may explore not only the surface web 132 but also the deep web 134. The gathered content 188 may comprise, for example, web pages, documents and other files, including media files such as graphics, video and audio files, scripts and other executable programs, etc. Additionally, content 188 retrieved by the content retrieval component 180 may include metadata. For example, the content retrieval component 180 of the deep web miner 112 may capture the result page corresponding to each relevant query result URL, and nothing more. Alternatively, the user may wish to capture each result page and then explore the pages that are linked-to by each result page. As noted above, according to aspects of the present invention, the user interface component 114 may be utilized to allow the user to define a strategy for capturing content and thus control the manner in which link exploration is implemented. Thus, link exploration may be constrained, e.g., by the total number of links, by link depth, domain, relevance of page content, etc. Link exploration may also be constrained by limiting the number of result pages that are captured.

The content 188 obtained by the content component 180 may be analyzed by the analysis component 182, so as to modify the search terms provided by the mining parameters component 174, which used to submit to the actual form 184. Moreover, the information returned from crawling operations performed by the content retrieval component 180 may be stored to local storage 122, e.g., by constructing a local navigable copy of the results as set out more fully herein. Moreover, the results may be dynamically conveyed to the user interface 114 so that the user can interact with the stored content while the deep web miner 112 iterates the search.

The content retrieval and analysis module 180 may also analyze the retrieved content. The results of this analysis are utilized by the query generator 182 to generate new content-based query terms 26 which are then used to update parameters maintained by the mining parameters component 176.

Deep Web Mining Tasks:

According to various aspects of the present invention, the deep web miner 112 maintains a collection of “Tasks”. Each task may embed abstract query parameters and collection parameters that support a single collection effort. Thus, a task may be initialized and ready for execution, executing, complete, initiated, paused, saved, etc. Correspondingly, a user may select previously saved tasks, which can then be re-initialized and/or re-executed/re-started. In such cases, any previously captured content may be discarded, archived, or otherwise saved. According to various aspects of the present invention, the deep web miner 112 may also be threaded so that multiple tasks can execute concurrently. The utilization of threads may provide improved performance and/or other performance benefits, for example, when many tasks must access web sites at distant locations and/or when tasks experience slow communications throughput. As such, the deep web miner 112 may create at least one deep mining thread associated with a defined new task to perform a mining process as set out in greater detail herein.

Cookie Handling:

During normal web browsing, a visited server may return cookies for local storage on the processing device hosting the deep web miner 112. Proper cookie handling is necessary for many websites to function correctly and predictably. For example, a conventional system that utilizes multiple web browser instances to concurrently explore a URL may consolidate or overwrite the cookies associated with each browser instance. According to various aspects of the present invention, the deep web miner 112 manages multiple isolated cookie spaces. For example, three cookie spaces may be managed per task to prevent unintended consolidation or overwriting of cookie spaces. The cookie spaces may include a first cookie space for deep web mining forms processing, a second cookie space for link exploration (web crawling) and a third cookie space for isolated browsing, which is described more fully herein. Depending on how each task is configured, these three cookie spaces may or may not be independent and isolated. Rather, user-configuration of cookie-space isolation may be implemented.

Output from the deep web miner 112 may be stored in multiple places. For example, as noted in greater detail herein, content including documents, media, executable code, etc., may be stored in a local file system, such as local storage 122 as a local navigable copy 124 of the content obtained by crawling locations across the network 104. Moreover, the documents, content and media may be mapped from task and URL by an embedded relational database. Also, metadata such as HTTP transactional metadata may be stored directly in a corresponding database. Once stored, the deep web miner 112 may provide capability to search, analyze, navigate, graph or otherwise manipulate or interact with the captured content, such as via an operator interacting with the user interface 114.

For example, for each executing or completed task, the deep web miner 112 may provide a tree component or other visual metaphor that shows each captured page and its role. The user may select a task and then click on tree nodes in order to browse captured pages with a conventional web browser in “isolation”. In isolation, the browser is blocked from requesting any page that has not already been captured by the task.

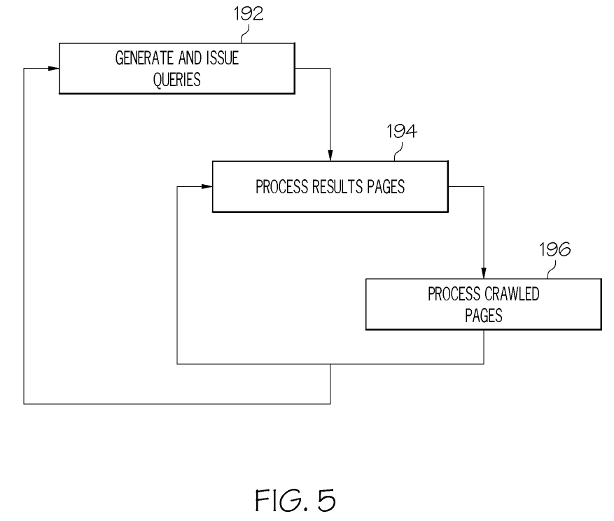

Referring to FIG. 5, according to various aspects of the present invention, the deep web miner 112 may iteratively continue nested processing cycles including forms submission and query at 192, URL results gathering at 194 and corresponding content gathering/crawling at 196 by crawling the URLs, with task-dependent user-definable termination criteria. A stopping event may be defined by running out of information to crawl, receiving a request for a new search or otherwise meeting a predetermined stopping criteria/criterion set by the user. For example, the user may specify a predetermined number of pages or links to follow. The user may also limit the size or types of information that is returned, etc. by setting user preferences in the user interface component 114. Moreover, other sequences may be utilized to perform deep web mining using the systems and techniques described more fully herein.

Exemplary User Interface Component:

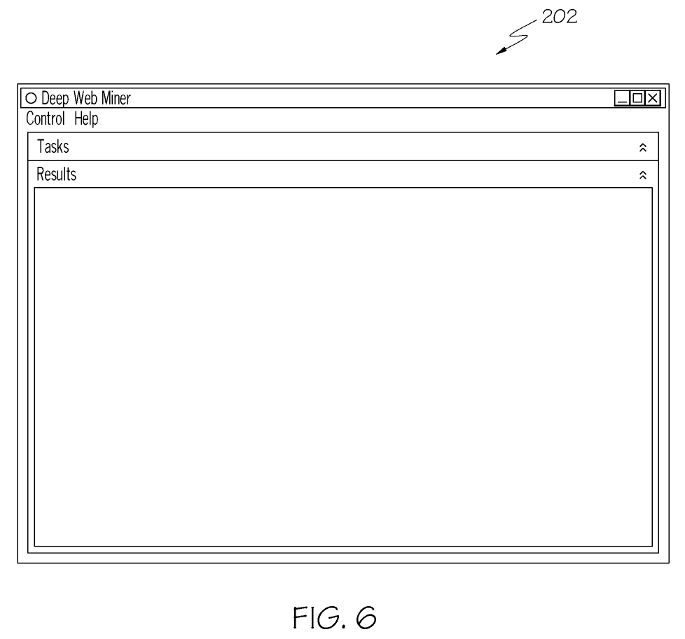

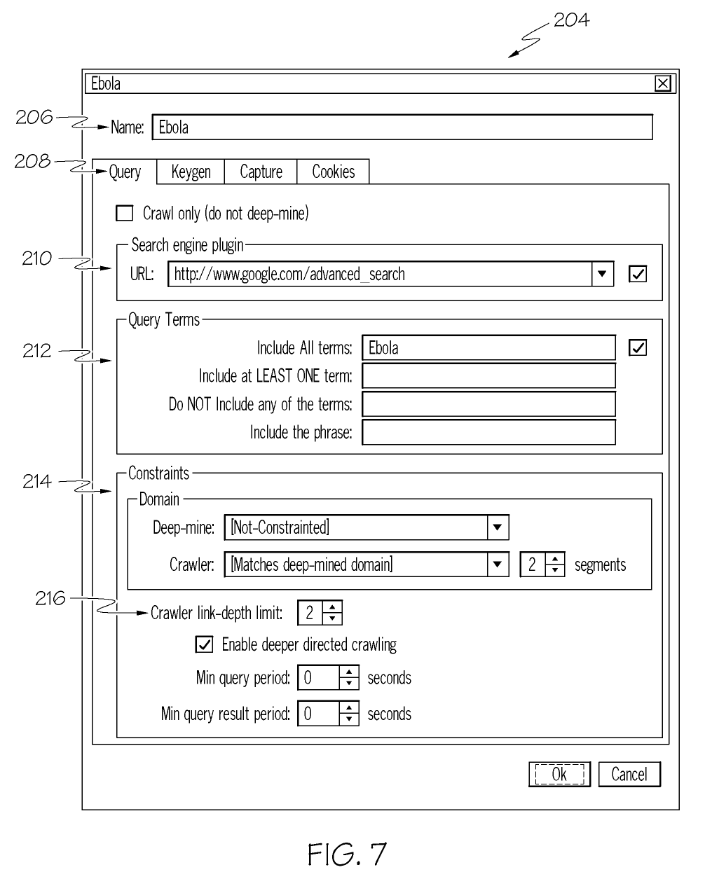

Referring to FIG. 6, a screen shot 202 illustrates an exemplary implementation of aspects of the user interface component 114 of the deep web miner 112, wherein a user has started the deep web miner 112, e.g., for the first time, and has no defined tasks. Referring to FIG. 7, after opening the deep web miner 112, a user may open a dialog 204 to create/define a new task corresponding to a concept space associated with a topic of interest to a user. In the illustrated exemplary dialog 204, the user may provide a name for the task at 206.

Moreover, the user may specify seed information, e.g., in a query tab 208. For example, the user may identify an on-line form at 210 to begin the iterative searching process. The identified form is then matched with a corresponding form-understanding plug-in as described in greater detail herein. The user may also enter search terms at 212. For example, as shown, the user has entered the term “Ebola” as a query term. The user may also be able to specify constraints at 214 and at 216, e.g., to constrain various mining and/or crawling parameters.

As illustrated, the user has constrained the crawled URL domains to match the highest-level 2 domain segments of the result URLs obtained by the deep web miner 112. For instance, if the search engine returns the result URL “www.cdc.gov/ncidod/dvrd/spb/mnpages/dispages/ebola.htm”, the highest-level 2 domain segments are “cdc” and “gov” so that crawling is subsequently constrained to explore links within the “cdc.gov” domain. The crawlers will thus not explore links in the “amazon.com” domain in this example. Although the deep web miner 112 obtains seed information with regard to the concept space including an on-line form and at least one search term in this example, other arrangements for obtaining seed information may alternatively be implemented as described more fully herein.

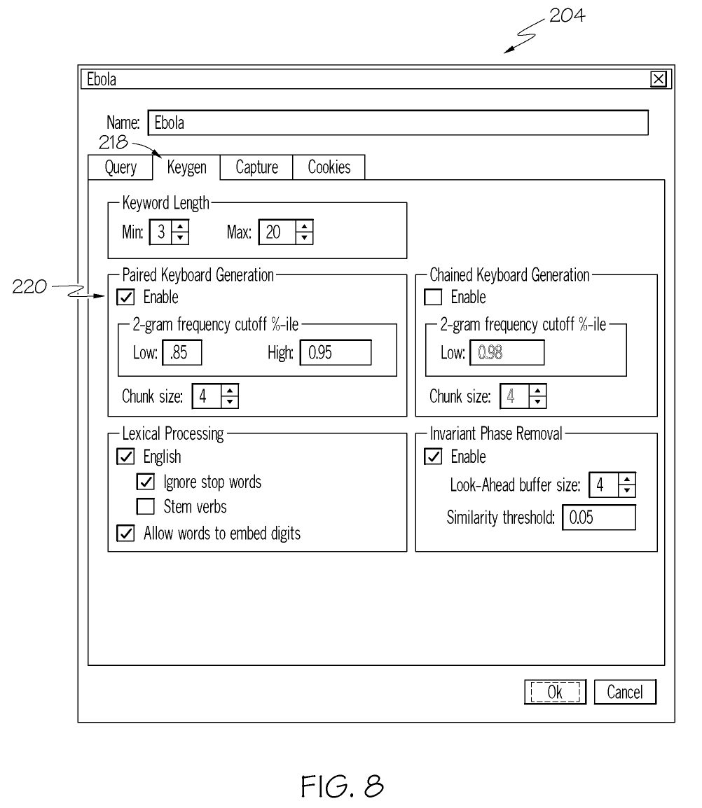

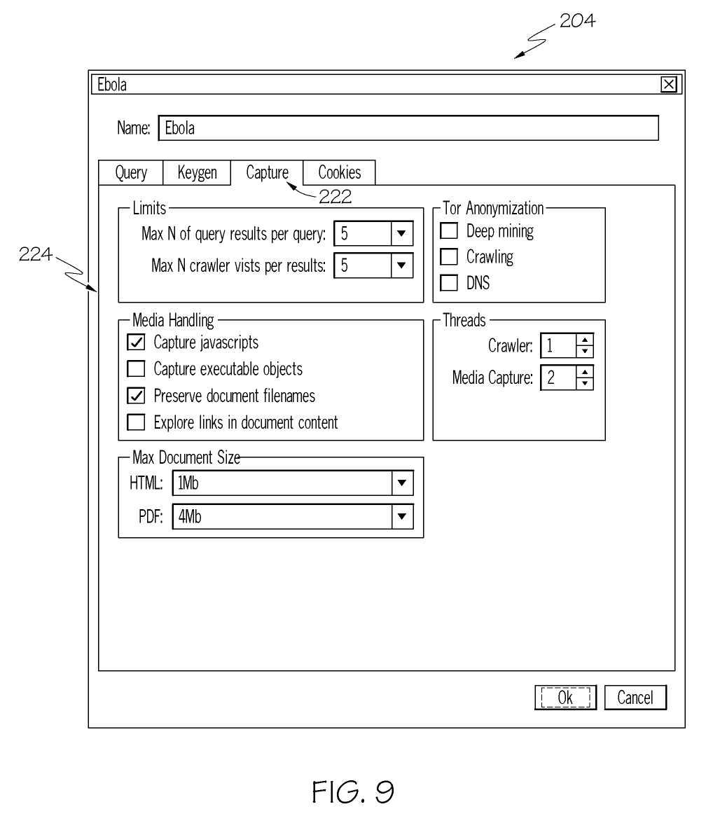

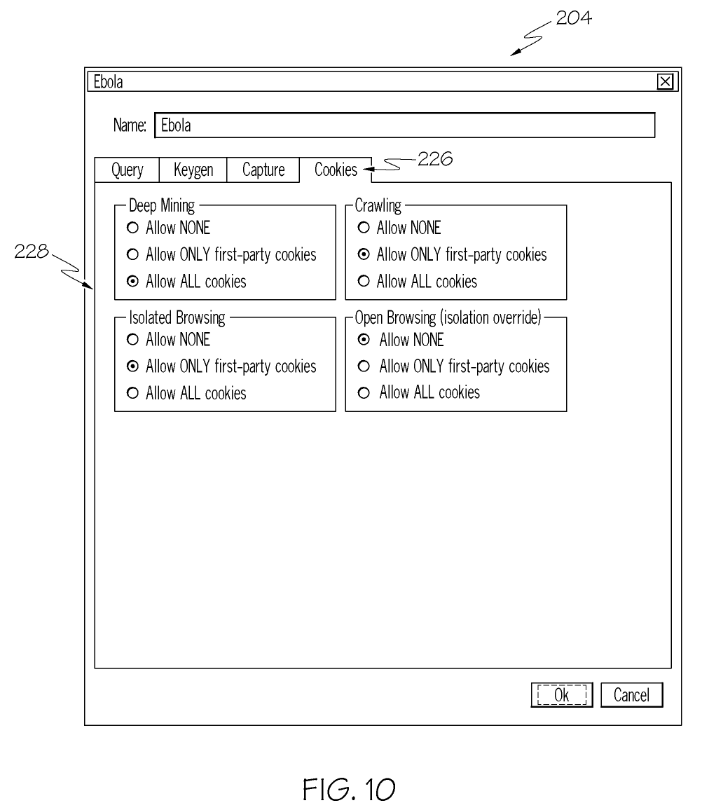

Referring to FIG. 8, a screen shot illustrates an exemplary KeyGen tab 218 of the dialog 204 to set up user defined keyword generation parameters 220. As shown, the user has altered the 2-gram frequency cutoff percentile (designated ‘%-tile’ in the figure). 2-gram frequency will be described in greater detail herein. Referring to FIG. 9, a screen shot illustrates an exemplary Capture tab 222, which is utilized to specify user parameters 224 regarding Crawler and Media-Capture threads. Herein, the user may set limits, such as on the maximum number of query results obtained per query issued, the maximum number of crawler visits per result, maximum size of files to collect, e.g., for HTML and/or non-HTML documents, media handling limits, thread processing limits, etc. Referring to FIG. 10, a screen shot illustrates an exemplary Cookies tab 226, which is utilized to specify user parameters 228 regarding Cookie privacy policies.

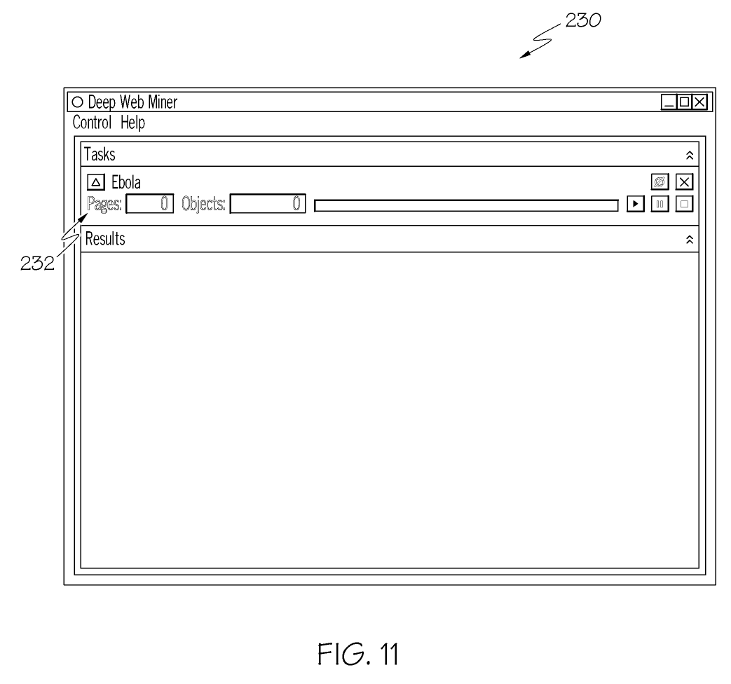

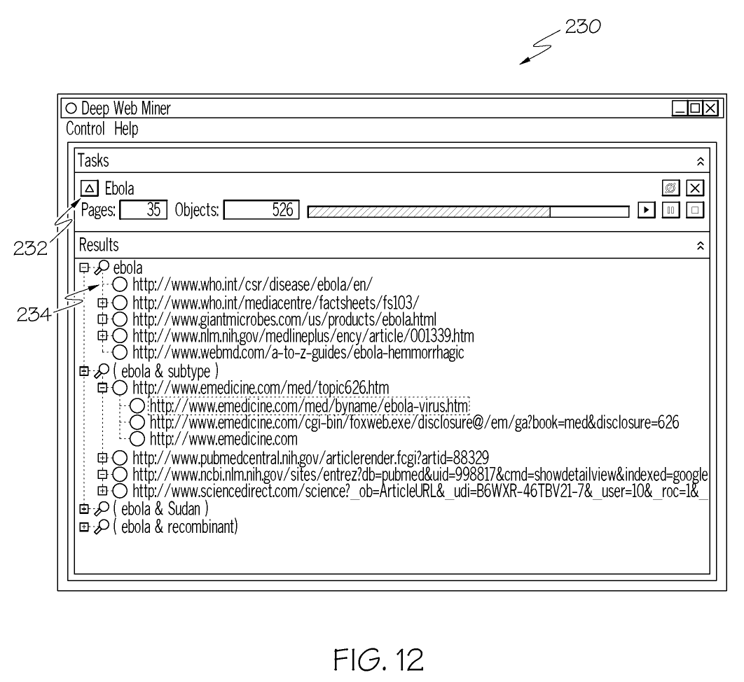

Referring to FIG. 11, a screen shot illustrates an exemplary display 230 wherein the new task 232, designated “Ebola”, is defined in the present example. Even though the task is selected, the lower-results pane is empty because the task has not yet been executed. Referring to FIG. 12, a screen shot illustrates the exemplary display 230 after the “Ebola” task has been started using task controls 232. The results of the deep web mining process are displayed in results pane 234. As shown, the highest-level of the results tree illustrated with magnifying glasses icons are the deep-miner queries. The next-to-highest level listings are the direct search results. The 3rd and deeper levels of the tree are crawled results. According to various aspects of the present invention, crawled results may override the user-defined depth constraint because they satisfy the query constraints. Such results may thus be distinguished in the results pane 234, such as by color, indicia, etc. In an illustrative example, crawled results that override user-defined depth constraints are displayed in green. According to various aspects of the present invention, selecting any URL in the displayed results pane 234 may open a web browser in an isolated local virtual web-space to view collected content corresponding to the task associated with the “Ebola”.

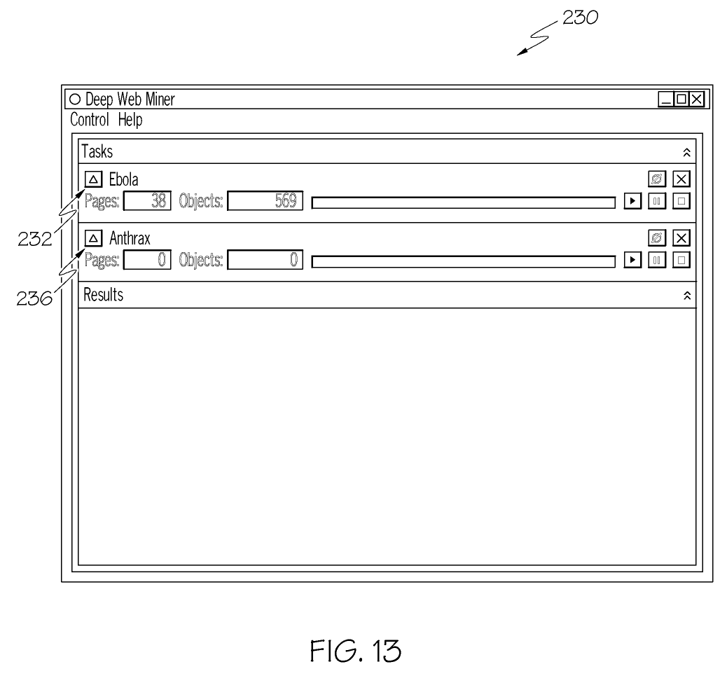

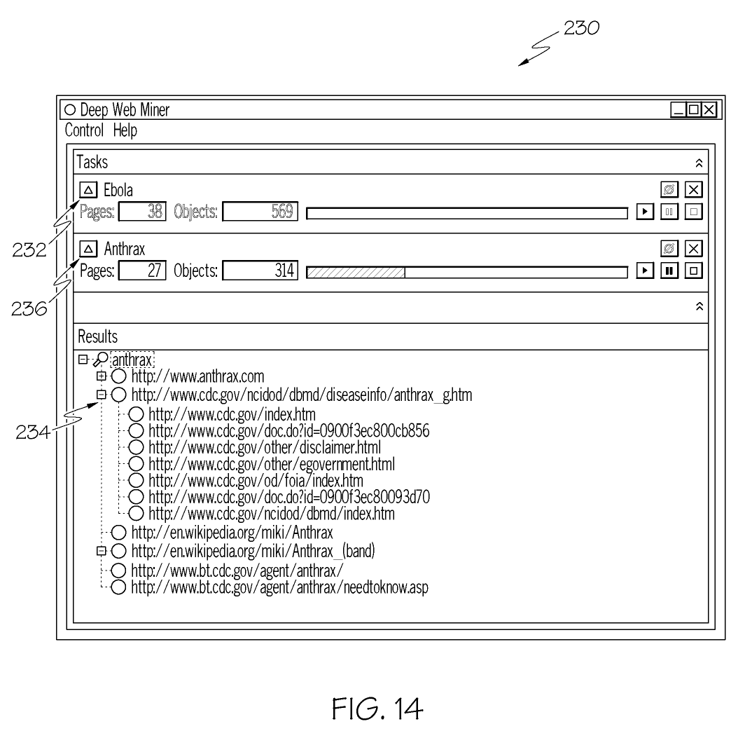

Referring to FIG. 13, a screen shot illustrates an exemplary screen display wherein the “Ebola” task 232 has been stopped and a new task 236, designated “Anthrax” has been created for purposes of illustration. Referring to FIG. 14, a screen shot illustrates the exemplary display 230 after the “Anthrax” task 236 has been started. In this exemplary screen shot, the “Anthrax” task 236 is selected in the upper pane, and “Anthrax” results are shown in the results pane 234. If the user clicks to select the “Ebola” task 232 in the upper pane, then “Ebola” results are shown in the results pane 234. Clicking on any result in the lower pane displays the collected web pages within the isolated virtual web-space that is associated with that particular task.

The User Interface Component—Mining Component Exchange:

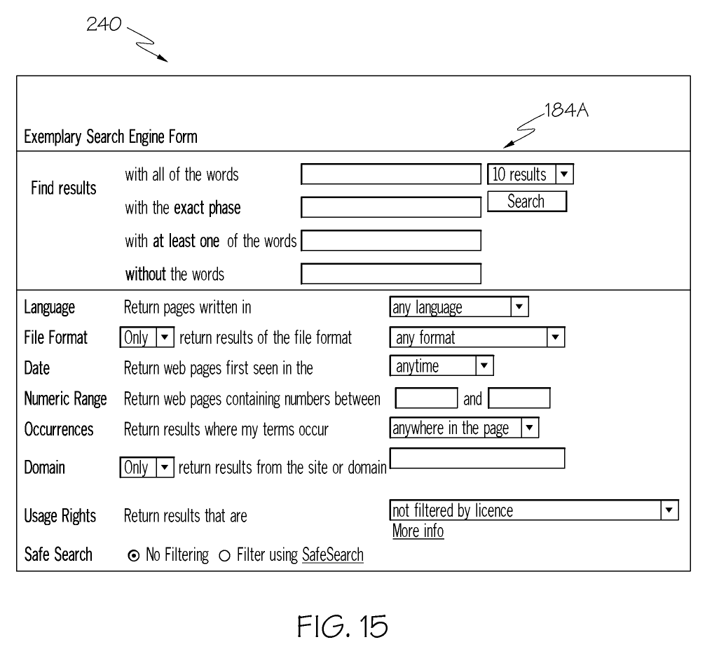

Referring to FIG. 15, a screen shot 240 is illustrated of an exemplary on-line form 184A, such as an accessed form 184 described more fully herein with reference to FIG. 4. The form 184A may be accessed for example, by targeting the URL entered at 210 in the query tab of the task dialog 204. This illustrative type of form is typical to what a user would see when using a traditional search engine. Forms such as these are accessed and populated by the form-understanding plug-ins component of the deep web miner 112 to initiate searches, as described more fully herein.

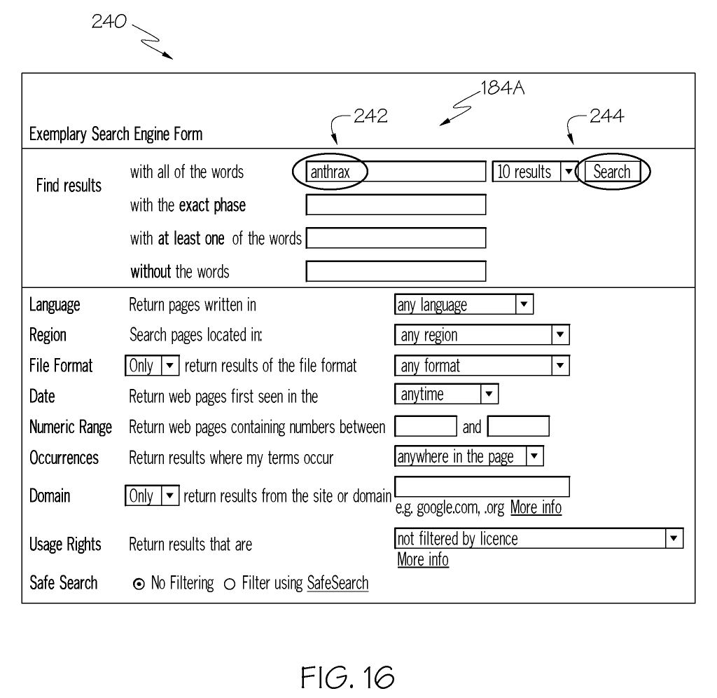

Referring to FIG. 16, a form-understanding plug-in has been selected from the plug-in component 176 that “knows” the illustrated form. Keeping with the above example, assume that the user has selected a topic of interest such as “anthrax”. The user has thus provided seed information to the deep web miner 112 which includes this topic of interest “anthrax”. The derived query terms/search parameters are mapped to appropriate fields on the actual form 184A by interaction between the selected form-understanding plug-in and the form. As a result, the exemplary search form is populated with properly formatted search terms 242 in the appropriate field(s) and the form-understanding plug-in triggers the search to be conducted, such as by implementing an appropriate submission technique, e.g., activating the “search button” 244 provided on the form. The deep web miner 112 thus automatically submits the query to the search engine to execute the search.

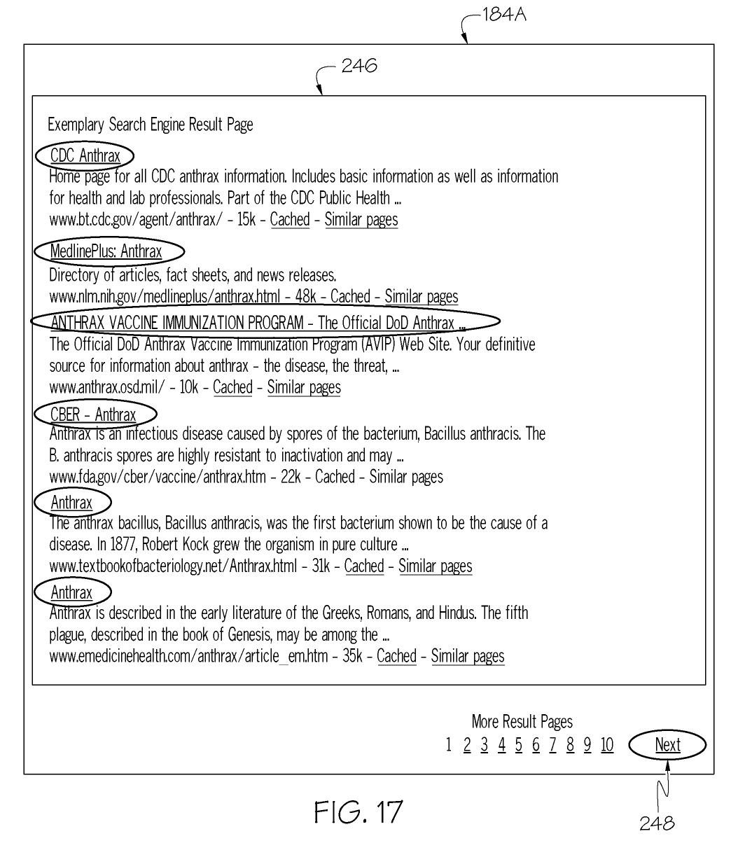

Referring to FIG. 17, a screen shot illustrates a partial listing of the results 246 of the executed search from FIG. 16. In general, the deep web miner 112 retrieves the results page of the search and analyzes the page information for relevant content. For example, depending upon user preferences, relevant query result URLs from the search may be obtained for subsequent crawling. In this regard, the processing may require obtaining more than one page of search results. If more results from the executed search are available than can be displayed on the exemplary result page, then the deep web miner 112 can continue iteratively retrieving additional results via interaction between the selected form-understanding plug-in and the targeted site, e.g. by simulating the activation of the “NEXT” link 248 or similar links on the results page 246, or through any other appropriate interactions with the corresponding form processing engine 186.

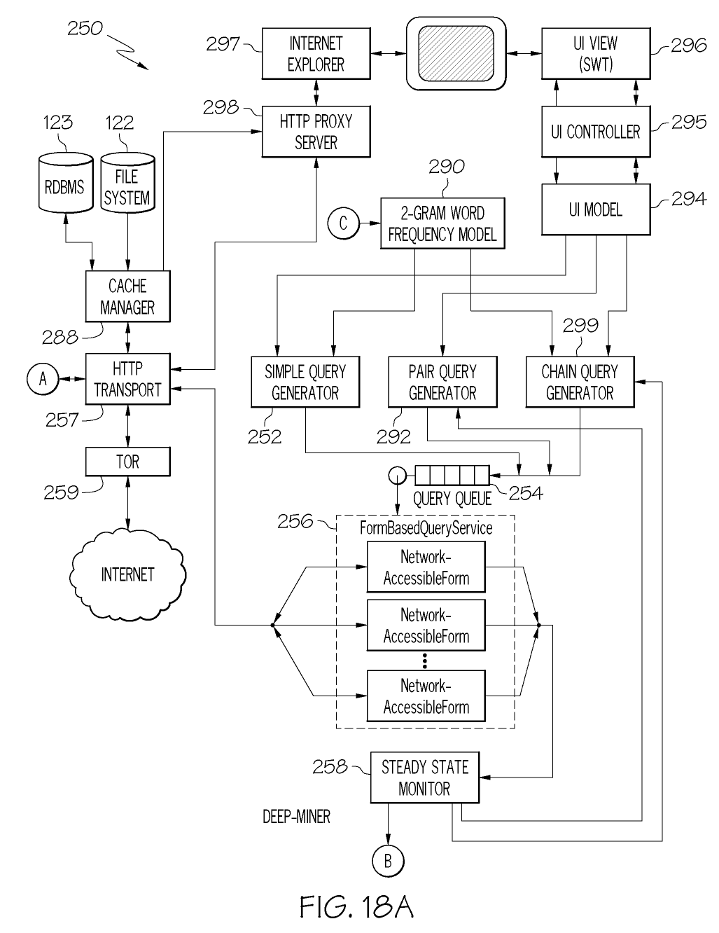

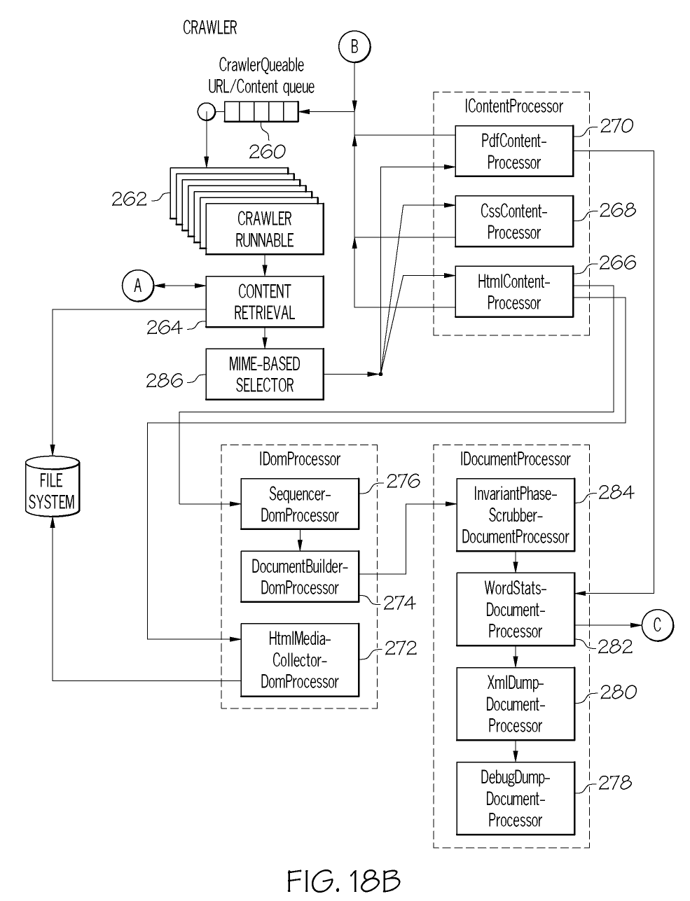

Referring to FIGS. 18A-B generally, a block diagram 250 of an exemplary implementation of the deep web miner is illustrated according to various aspects of the present invention. In the illustrated implementation, a user begins by creating a deep web mining task, loading seed information and starting the task as described more fully herein. In response thereto, a user-interface thread creates a single new “deep-mining thread” to execute deep-mining activities on behalf of the task. The deep-mining thread creates a pool of crawler and content-service threads and holds initial query parameters that are used to generate one or more simple queries. The flow of processing is as follows:

The deep-mining thread generates one or more queries at 252, e.g., using a query generator. Each query is generated from keyword information that is specified entirely within the task, e.g., from user provided seed information and/or generated keywords. The deep-mining thread also queues the queries at 254 for subsequent processing in the query queue.

The task declares a specific implementation of an abstract forms-based query service at 256. For example, the task may declare a specific implementation of an abstract forms-based query service in a corresponding content-service thread that executes a deep mining process by matching an identified on-line form to a corresponding form-understanding plug-in that understands the format of the on-line form. In this regard, the selected form-understanding plug-in simulates the submission of a query and identifies relevant result addresses.

The abstract forms-based query service provides a simple, uniform interface for all implementations. In this regard, implementations may be realized by form-understanding plug-ins which are discovered when the deep web miner 112 is initialized as described more fully herein. The declared implementation transforms the query into an appropriate network request, e.g., an HTTP request, and transacts with an HTTP transport component at 257 to retrieve one or more query result pages. Query result pages are ultimately transformed into a stream of individual result URLs.

After initialization and generation of queries, the deep-mining thread implements a steady state (SS) monitor at 258 that iterates until the task is complete. The SS monitor invokes the form-based query service to retrieve the individual result URLs. As noted in greater detail herein, the maximum number of result URLs may be limited by a task parameter, e.g., a mining parameter, which can be provided by the user when the deep web miner task is created or can be limited by default parameters within the deep web miner 112 parameters listings. When the limit is reached, if utilized, the SS monitor may attempt to generate additional queries. If the limit is not reached, but the form based query service is unable to provide sufficient result URLs, then the SS monitor may request that additional queries be generated.

Next, query result addresses are queued in a crawler queue. For example, the SS monitor may invoke a crawler method to push individual result URLs onto the head of a crawler queue at 260. The crawler maintains a pool of threads at 262 that asynchronously service the URLs. According to various aspects of the present invention, while the crawler URL queue is empty, all crawler threads may sleep. When URLs are queued in the crawler queue, crawler threads are awakened to service them. If all crawler threads are busy, then additional URLs remain queued until crawler threads become available to handle them. If a crawler thread completes processing its URL and there are no more URLs in the queue, then the thread goes to sleep.

Each result address may be asynchronously serviced by a corresponding crawler thread that obtains content and/or metadata that is cached in a local storage medium. For example, each crawler thread may pull and service a URL from the tail of the crawler queue. In this regard, the crawler attempts to retrieve the content associated with the URL at the content retrieval component at 264. Retrieved content may be stored directly in a file system, e.g., the local storage 122 as described with reference to FIG. 1. HTTP transactional meta-data may also be stored at the HTTP transport layer, e.g., in a relational database management system (RDBMS) at 123, as described more fully herein.

The system processes the content of the returned results and may update a display with a listing of the mined results, e.g., by updating the user interface 114 wherein the user may browse a local navigable copy of the crawled results in isolation by selecting a navigable entry of the listing.

According to various aspects of the present invention, retrieved content undergoes a processing workflow. Initially, “Content” consists of a buffer of bytes. Content may then be processed by a sequence of one or more “processors”. For example, each processor may be associated with a different returned file type. When a processor is done processing its content, it may invoke one or more additional target processors. In this way, processors do a bit of work and then feed their results into other processors.

In the present illustrative example, there are three types of retrieved content, including raw content that consists of bytes or character strings, structured HTML object hierarchies, which are also referred to as document object models (DOMs), and structured text documents. In practice, other types of retrieved content may also/alternatively be defined.

As used herein, processors that consume raw content are referred to as “Content Processors” and may implement a standard interface, designated herein as IContentProcessor. Exemplary IContentProcessors include an HtmlContentProcessor 266, a CssContentProcessor 268 and a PdfContentProcessor 270.

Processors that consume DOMs are referred to herein as “DOM Processors” and implement a standard interface designated IDomProcessor. Exemplary IDomProcessors include an HtmlMediaCollectorDomProcessor 272, a DocumentBuilderDomProcessor 274 and a SequencerDomProcessor 276.

Processors that process structured text documents are referred to herein as “Document Processors” and implement a standard interface designated IDocumentProcessor. Exemplary IDocumentProcessors include a DebugDumpDocumentProcessor 278, an XmlDumpDocumentProcessor 280, a WordStatsDocumentProcessor 282 and an InvariantPhraseScrubberDocumentProcessor 284.

Some processors may be utilized to transform one type of content into another. For example, an HtmlContentProcessor at 266 may build a DOM that is passed to a target, e.g., an HtmlMediaCollectorDomProcessor 272. This system of processors may be utilized, for example, where each type of document, such as HTML, PDF, cascading style sheets (CSS), character strings, structured text documents, etc., requires different treatment to access and collect the information found therein. As such, a plurality of processors may be utilized in the deep web miner workflow. See for example, the table set forth below for an exemplary collection of processors.

TABLE 1

| | | | | Extracts | Collects | |
|---|---|---|---|---|---|---|
| Name | Input | Output | Target | URLs | Media | Description |
| HtmlContent- | Content | DOM | Sequencer- | Yes | No | Parses HTML |
| Processor | (text/html) | DOM | Dom- | | | content |
| | | | Processor or | | | Builds DOM |
| | | | HtmlMedia- | | | Collects URLs |
| | | | Collector- | | | for crawler |
| | | | Dom- | | | |
| | | | Processor | | | |
| PdfContentProcessor | Content | Document | WordStats- | Yes | No | Parses PDF |
| | (application/ | | Document- | | | content |
| | pdf) | | Processor | | | Builds |
| | | | | | | Document |
| | | | | | | Collects URLs |
| | | | | | | for crawler |
| CssContent- | Content | | | Yes | Yes | Parses CSS |
| Processor | (text/css) | | | | | content |
| | | | | | | Builds flat |
| | | | | | | DOM |
| | | | | | | Collects URLs |
| | | | | | | for crawler |
| | | | | | | Retrieves and |
| | | | | | | stores CSS- |
| | | | | | | referenced |
| | | | | | | media |
| SequencerDom- | DOM | DOM | Document- | No | No | Collects and |
| Processor | | | BuilderDom- | | | queues DOMs |
| | | | Processor | | | from multiple |
| | | | | | | threads |
| | | | | | | Processes |
| | | | | | | queued DOMs |
| | | | | | | sequentially, |
| | | | | | | from a single |
| | | | | | | thread |
| | | | | | | Prevents race |
| | | | | | | conditions in |
| | | | | | | thread-unsafe |
| | | | | | | code |
| HtmlMedia- | DOM | File(s) | | No | Yes | Examines |
| CollectorDom- | | | | | | DOM for |
| Processor | | | | | | references to |
| | | | | | | media |
| | | | | | | Retrieves and |
| | | | | | | stores |
| | | | | | | referenced |
| | | | | | | media |
| Document- | DOM | Document | Invariant- | No | No | Extracts |
| BuilderDom- | | | Phrase- | | | HTML element |
| Processor | | | Scrubber- | | | content |
| | | | Document- | | | Ignores style |
| | | | Processor | | | and script |
| | | | or | | | content |
| | | | Wordstats- | | | Inserts implicit |
| | | | Document- | | | line breaks |
| | | | Processor | | | Constructs |
| | | | | | | structured text |
| | | | | | | Document |
| | | | | | | objects |
| InvariantPhrase- | Document | Document | Wordstats- | No | No | Buffers |
| Scrubber- | | | Document- | | | structured text |
| Document- | | | Processor | | | Documents |
| Processor | | | | | | Removes |
| | | | | | | invariant |
| | | | | | | phrases such |
| | | | | | | as headers, |
| | | | | | | navigation |
| | | | | | | labels, etc. |
| Wordstats- | Document | Document | XmlDump- | No | No | Collects 2- |
| Document- | | | Document- | | | gram word |
| Processor | | | Processor | | | statistics |
| | | | or none | | | within phrases. |
| XmlDump- | Document | File | DebugDump- | No | No | Exports |
| Document- | | | Dom- | | | compiled text |
| Processor | | | Processor | | | analytic |
| | | | or none | | | metadata to |
| | | | | | | XML files. |
| DebugDump- | DOM | File | | No | No | Dumps debug |
| DomProcessor | | | | | | information to |
| | | | | | | log file(s) |
| DebugDump- | Document | File | | No | No | Dumps debug |
| Document- | | | | | | information to |
| Processor | | | | | | log file(s) |

The crawler maintains registries for content processors, e.g., processors at 266, 268, and 270 that implement a standard interface designated IContentProcessor. The crawler also maintains registries for processors that consume DOMs, e.g., processors at 272, 274 and 276 that implement a standard interface designated IDomProcessor. The registry of content processors may be keyed by type, e.g., the Multipurpose Internet Mail Extensions (MIME) type in the illustrative example. After retrieving the content associated with a URL, the crawler examines the content MIME type and uses a MIME-based selector at 286 to dispatch the content to the correct content processor. The deep web miner 112 may thus support processes such as HTML, CSS, and PDF, MIME types, although additional and/or alternative types may be supported. If no processor is found for the MIME type of the content, then content is not processed any further.

As noted above, the illustrative IContentProcessor contains several different processors of which three exemplary processors will be explained herein. The HtmlContentProcessor at 266 may use an open source HTML parser to build a hierarchical “document object model” (DOM) of the HTML, which allows for detailed structural analysis. The HtmlContentProcessor at 266 forwards the DOM to every IDomProcessor in the crawler's registry, including the HtmlMediaCollectorDomProcessor at 272 and the SequencerDomProcessor at 276. The CssContentProcessor at 268 may use a primitive parser to build a flat document model that exposes references to media, and to other included cascading style sheets. The CssContentProcessor at 268 collects media (e.g., images). The CssContentProcessor at 268 may also extract references to nested cascading style sheets and feed them back to the crawler queue for subsequent crawling. The PdfContentProcessor at 270 may extract text from PDF documents and scan the extracted text for substrings that are syntactically valid URLs. The URLs extracted from these processors may then be fed back to the crawler queue 260 so that crawling of additional linked content may continue. The text content extracted may be composed into structured documents subject to one or more Document Processors.

Before a DOM is built, the web page data is raw content. If the web page consists of HTML, then the HtmlContentProcessor at 266 builds a DOM and forwards it to the HtmlMediaCollectorDomProcessor at 272 for additional processing. The HtmlMediaCollectorDomProcessor at 272 examines all HTML elements and identifies those with references to non-crawlable external media such as images, video, script, audio, etc. As noted in greater detail herein, a pool of threads may be used to collect and store external media in local storage 122. Moreover, the mappings of URLs to media files may be stored in the embedded database 123, e.g., the RDBMS, by a cache manager 288.

To allow for the unpredictability of network communication latency and throughput, content processing is performed on multiple crawler threads simultaneously, e.g., using the SequencerDomProcessor 276. This may prevent for example, work to stall, such as where a single process is waiting for communication with slow websites. However, after data retrieval is complete, multiple threads no longer serve a useful purpose. To the contrary, multiple threads may decrease efficiency in CPU-bound processing. Thread-safe code is also more difficult to develop, debug, and maintain. However, the above issues are avoided by collapsing the multiple crawler threads to a single thread, e.g., after data retrieval is complete. For example, the above issues are avoided by collapsing the SequencerDomProcessor workflow multi-threading into a single thread, rather than support multi-threaded processing. However, other configurations may alternatively be implemented.

The first stages of DOM processing identify URLs that are crawlable via the DocumentBuilderDomProcessor at 274, as well as reference pages and media that need to be collected. Collecting relevant pages and media are tasks suited to the deep web miner 112, and to maximize data collection, the deep web miner 112 can generate new queries in the deep miner. This is done by analyzing the text collected while the deep web miner 112 is iterating. For example, the deep web miner 112 may be given seed information requesting information about the topic “anthrax”. The deep web miner 112 may collect numerous web pages concerning “anthrax”. Moreover, for further exploration, the deep web miner 112 may need to decide what concepts are related to “anthrax”. To accomplish this task, the deep web miner 112 may be required to analyze the text content of the collected pages. The use of the DOM allows the deep web miner 112 to separate text content from HTML markup. Each HTML element may have text content.

However, some HTML elements, such as SCRIPT and STYLE have text content that is not domain content. The DocumentBuilderDomProcessor at 274 extracts text content, and forms it into structured text document objects, which are hierarchical structures that expose the linguistic organization the text.

In this regard, the content of the returned results may be processed by identifying the text content of returned results, performing a linguistic organization of the identified text, identifying new terms associated with the corresponding concept space and iteratively repeating the mining process until a predetermined stopping event is detected.

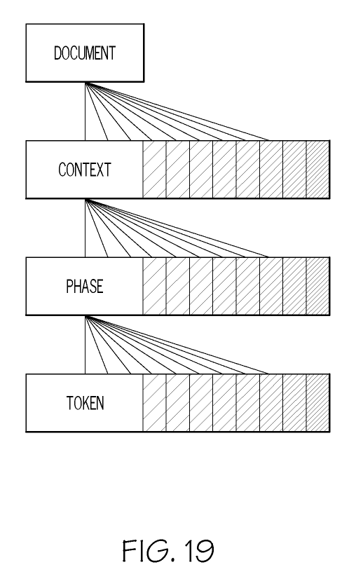

Referring to FIG. 19, a linguistic organizational breakdown is shown. A document may contain an ordered sequence of child contexts. A context may contain an ordered sequence of phrases and a phrase may contain an ordered sequence of tokens. From this structure, it is relatively easy to determine which tokens appear in the same documents, contexts, or phrases.

Referring back to FIGS. 18A-B, the text content of a web page may contain uninformative boilerplate. Boilerplate may include headers, labels for navigational links, copyrights, legal warnings, and so forth. Boilerplate text is generally not related to the user-specified topics of interest and contaminates text-based statistics as will be described in greater detail herein.

An InvariantPhraseScrubberDocumentProcessor at 284 compares structured documents, identifies boilerplate texts, and removes them. The final text analytic stage of document processing, e.g., the WordStatsDocumentProcessor at 276 involves collecting frequency statistics on individual tokens as well as frequency and weighted proximity statistics on pairs (2-grams) of tokens that co-occur within phrases. Statistics may then be used to identify tokens that correlate with the user provided seed information. For instance, the words such as breathing, transmission, vaccine, bacteria, and CDC are highly correlated with “anthrax”. The WordStatsDocumentProcessor at 282 collects statistics expressed as tokens in document structures. As a few illustrative examples, the analysis aspects according to various aspects of the present invention may attempt to locate words that are near a given key word where such additional words are not close to other words. In this regard, a ranking of pairs of words may be created. Thus, terms such as Ebola+fever may be heavily exploited and rank near the top of the list. As such, this pairing may be deemed as not worth searching as the pair is too highly correlated. Rather, the system may jump somewhere spaced from the top of the keyword pair list, e.g., towards the middle of the pair listing. As an example, the system may select the 60%-80% span of ranking to considering secondary search terms.

During processing, a large amount of meta-data may be generated. Some of the meta-data may be exported to XML documents for unspecified external processing. This process is performed by the XmlDumpDataDocumentProcessor at 280. The final step in the workflow handled by the illustrated crawler is processed by the DebugDumpDocumentProcessor at 278, which outputs debugging information to log file(s).

The SS monitor at 258 observes the number of query result URLs that are processed by a 2-Gram Word Frequency Model component at 290, and the number of crawled URLs that are processed. When crawling is complete and either no more query results exist, or the user-specified limit on the number of query results has been met, the SS monitor at 258 may request generation of additional queries using the results of the WordStatsDocumentProcessor at 282. When additional queries are generated, frequency and 2-gram statistics are drawn from the 2-gram word frequency model at 282. This model is built by the WordStatsDocumentProcessor at 282 and is forwarded to the 2-Gram Word Frequency Model component at 290.

According to aspects of the present invention, paired queries are generated by the Pair Query Generator at 292. The user may determine whether or not the deep web miner 112 should generate additional queries. If additional queries are to be generated, the user may determine which queries to generate, such as paired queries, chained queries, or both. The user may also control mining parameters using the user interface to control the generation of additional queries and/or to otherwise steer the deep web mining process. If queries are generated, the deep web miner 112 may execute the task until it is stopped, such as by the user.

The user interface may provide a work area for the user to browse results that have been captured. As illustrated, the work area includes a UI Model at 294, a UI Controller at 295 and a UI View at 296. The user invokes the interface for example, by selecting a task, and then navigating a tree widget to a result URL as described more fully herein. Under this configuration, clicking on a result URL may launch an instance of a web browser and display the result.

The web browser at 297, such as Internet Explorer by Microsoft Corporation of Redmond Wash., may be operated in a modified windows environment. For example, when the environment is prepared, a hook may be set in the registry that redirects web browser transactions through an HTTP proxy server at 298. In this regard, transactions within previously opened web browser windows are not affected by the redirection. On shutdown, the original windows environment may be restored.

While the windows environment is modified, all web browser transactions may be directed to an HTTP proxy server at 298 that is part of the deep web miner 112. The proxy server at 298 may examine each requested URL and determine whether or not the URL is in the deep web miner's page cache 288.

If the URL is found in the cache, e.g., by the cache manager at 288, the content is located on the file system 122, the original HTTP transactional meta-data is restored and the content is delivered in response to the HTTP request. If the URL is not found, then an appropriate status code, such as an HTTP status code of “403-Forbidden” may be returned. The modified environment thus prevents unintentional access to the original network data source in the event that the workstation network is enabled. While browsing through the DWM proxy server, all HTTP requests may be matched both by URL and by the currently selected task.

According to various aspects of the present invention, workflow is defined by nested query, results, and crawling cycles with task-dependent user-definable termination criteria. Various aspects of the deep web miner may provide collection of abstract query terms with execution-time mapping to web-page implemented terms by plug-in forms-based query services. Moreover, the deep web miner may be configured to detect and crawls URLs embedded within PDF, CSS and other forms of documents and files, performs text-analytics against PDF content, etc.

Various aspects of the present invention provide the ability to constrain results pages to the internet domain, or any super-domain of the search engine. Various aspects of the present invention further provide the ability to constrain crawled pages to the domain, or any super-domain of the search engine or the domain or any n-segments of the domain of any results page. Moreover, a constrained crawling depth may be relaxed by satisfaction of abstract query parameters. Various aspects of the present invention further provide the ability to specify a number of threads for crawling and media collection during task execution.

Still further, various aspects of the deep web miner provide the ability to consolidate throttling across tasks that access the same query service implementation. This may be utilized, for example, to simulate the frequency and speed at which humans may access a corresponding query service, where such may be required to ensure successful query implementation thereof.

Still further, as noted above, various aspects of the deep web miner provide lexical processing of HTML text content including construction of text Document structure, the detection and removal of Invariant phrases, 2-gram word frequency within phrase, weighted by proximity, and techniques to find words with strongest correlations to words within disjunctive and conjunctive sets of words.

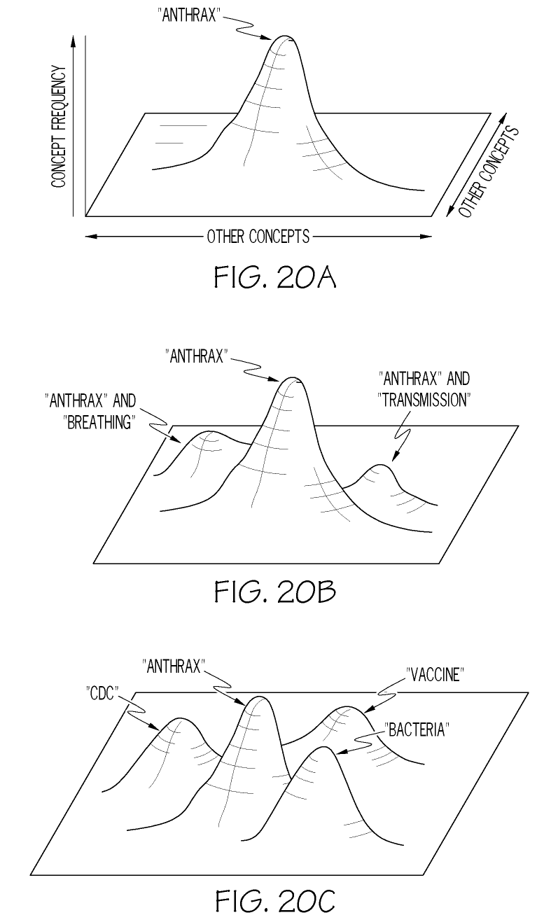

Referring now to FIG. 20A, an example illustrates a technique to generate “paired queries” with parameterized relevance ranking limits as noted previously. A single paired query takes an existing query and narrows it by pairing it with a single additional conjunctive term that has been determined to be weakly correlated with all existing primary terms. Keeping with the above example, assume that a search is conducted using a search engine that returns a significantly large number of pages, e.g., related to “anthrax”. If the deep web miner is configured to return less than the entirety of search results, e.g., a small percentage of the search results, then the returned pages may be chosen based on some statistical measure, e.g., the number of times that “anthrax” appears in the content of each page. Consequently, the mined pages may cover a very narrow range of concepts related to “anthrax”.

Assume as yet another example, if the deep web miner captures a plurality of pages, e.g., 100 pages, it may be determined that the terms “breathing” and “transmission”, are related to “anthrax”. Thus, the deep web miner's Pair Query Generator 292 issues queries “anthrax AND breathing”; “anthrax AND transmission”, etc. The effect, after many such pairings, is to broaden the range of explored concepts.

Referring now to FIG. 20B, according to various aspects of the present invention, the user may be able to control the breadth of the mined concept space by controlling how closely paired concepts, e.g., “breathing” or “transmission” must relate to the primary concept “anthrax”, as well as controlling the number of paired queries.

Referring now to FIG. 20C, according to various aspects of the present invention, a technique is provided to generate “chained queries” with parameterized relevance ranking limits, e.g., as may be implemented by a Chain Query Generator 299 illustrated in FIG. 18A. A chained query replaces primary query terms with alternative terms that have been determined to be strongly correlated with all primary terms. The effect is to broaden the range of explored concepts. Chained queries are further away from the primary concepts than paired queries. For example, chained queries may be useful for exhaustively mining websites. Moreover, chained queries can be combined with paired queries.

Various aspects of the present invention provide the ability to limit lengths, such as minimum and maximum number of generated query keywords. Additionally, the deep web miner provides the ability to limit text analytics, such as to English language nouns, verbs, adjectives, and adverbs with recognition of hyphenation, common abbreviations, contractions, ordinals, possessive contractions, etc. The deep web miner may also enable verb stemming, which allows similar verbs to be treated equally during query generation. Also, the deep web miner may provide the ability for a user to interactively select and prioritize lists of concepts used to generate paired and chained queries.

The deep web miner may provide task support, such as for multiple tasks where each task corresponds to a specific deep-mining goal. In this regard, each task may be parameterized, executed, stopped, paused, reset, or deleted independently and concurrently. Task parameters may also be independently persisted and completed task results may be independently persisted. Further, tasks may be re-parameterized during execution and new parameters are adopted at the earliest possible time. Task re-parameterization may be transactional and multiple parameters may be set but are applied or rejected together.

According to various aspects of the present invention, the user interface may provide a single view of all tasks, task execution status, and collected results of selected task. The user interface may also provide a tree view of selected task's results that illustrates queries, each result page, each crawled page, and each deeply-crawled page. Moreover, the user interface may allow the user to set combinations of deep-mined results, by URL, including union, intersection, and difference. Still further, the user interface may allow the user to specify a unique “current” task. If the task is executing or has completed execution, then selecting the task loads the user interface with the task's results. The user interface may also display the progress of each task, including the number of pages and media objects collected, as well as a dynamically updated meter that represents data capture bandwidth for the task.

Task termination may be synchronized with deep-mining, crawling, and media-capture threads in order to avoid incomplete or broken pages. For instance, an HTML page may contain a FRAMESET that refers to multiple FRAMEs, where each FRAME refers to an HTML document, each HTML document may refer to multiple media objects and cascading style sheets (CSSs), and each CSS may refer to multiple media objects and/or other CSSs. The “reference tree” for the original FRAMESET document may include dozens or hundreds of URLs. If the original FRAMESET document has been captured, and the task is subsequently terminated, either explicitly, or by termination of the entire DWM application, then the DWM will continue to capture referents until the entire reference tree is completed, or until a timeout is reached.

According to further aspects of the present invention, task cloning may be implemented. For example, the deep web miner may be utilized to create a parameterized but not-yet-executed copy of a task.

According to further aspects of the present invention, the deep web miner may provide anonymity and/or security. As an example, the deep web miner may implement anonymous deep-mining, crawling and/or DNS using Tor (“The Onion Router”), e.g., as seen by the TOR processor 259 in FIG. 18A. Further, the deep web miner may implement user-configurable query submission and results URL collection throttling. For example, the deep web miner may provide the ability to throttle query submission rate in order to mimic human operation. The deep web miner may also provide the ability to throttle results retrieval rate in order to mimic human operation. Moreover, the deep web miner may throttle coordination among multiple deep web miner instances running on a common LAN. The use of throttling may allow the deep web miner to collect information without appearing as an automated software agent to the form processing engine 186, e.g., by operating at a lower speed to “throttle” the aggressiveness of the search and retrieval to act as if being manually steered by an operator. In a related aspect, the use of threads as described more fully herein allow multiple hits to corresponding pages at the same time. Thus for example, each thread may hit a site only once every 30 seconds (or some other defined time interval). However, multiple sites may be visited concurrently when multiple threads are used to deploy crawling efforts.

Still further, the user interface may provide isolated browsing that uses a proxy server to mimic the HTTP transactions that occurred during data collection while constraining browsing to previously-collected results related to the currently-selected task. Thus, an isolated virtual web space is created. Moreover, such isolated virtual web spaces may be created for each task. Isolated browsing may also prevent uncontrolled scripts and executable objects from executing, e.g., to contact remote web servers. Also as noted in greater detail herein, the deep web miner may be capable of isolated cookie spaces. This allows, for example, independent cookie handling policies, such as None, All and First-Party.

A form-understanding plug-in may not remain effective in perpetuity, considering that a form processing engine 186 may institute changes that render aspects of a form-understanding plug-in obsolete. For example, a given web site form may change the way that results are displayed, the logic used to implement search terms may be changed, the form may be relocated or removed, etc. As an illustrative example, a form may change from returning results in plain HTML to utilizing a JavaScript-based approach. However, according to aspects of the present invention, tools are provided that allow a user to create new form-understanding plug-ins and/or to edit, revise, modify or otherwise adapt the form-understanding plug-in to accommodate certain changes. Moreover, such tools allow a user to adapt the deep web miner 112 to accommodate new and/or changing forms without requiring the user to understand how to write computer program code.

As noted in greater detail herein, the deep web miner 112 may leverage an extensible form-understanding plug-in architecture to enhance automated processing of on-line forms, e.g., by allowing form-understanding plug-ins 176 to be customizable to accommodate predetermined and/or arbitrary form characteristics. Moreover, the extensible form-understanding plug-in architecture may provide tools that allow users and/or developers to expand or add to the capabilities of the form-understanding plug-ins 176, such as by providing the capability to add new plug-ins, modify existing plug-ins, delete obsolete plug-ins, etc.

According to aspects of the present invention, a plurality of approaches may be utilized to create form-understanding plug-ins 176. For example, a user may “teach” a form-understanding plug-in how to interact with a form by demonstrating form interaction, e.g., by pointing to a site containing a form, pointing to anchors and other distinguishing features and having the system “learn” patterns necessary to be able to interact with the form. Still further, an intelligent agent may be able to learn how to use a form without human intervention, or with minimal human assistance.

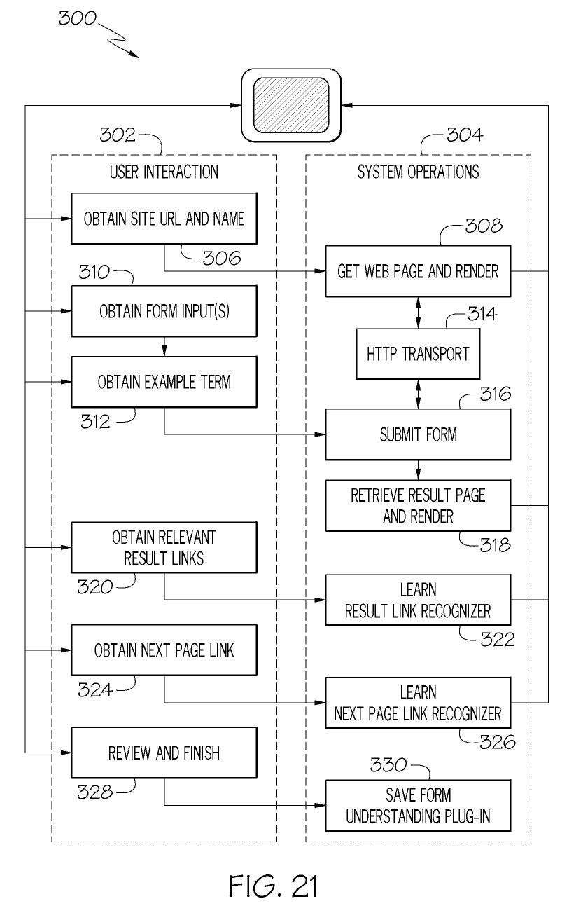

Referring to FIG. 21, a flow diagram 300 illustrates an exemplary approach to providing a tool for creating, editing, modifying or otherwise manipulating form-understanding plug-ins 176. In an illustrative implementation, the user interface 114 may include an “Add Site Plug-In” component that provides an interactive dialog and underlying capabilities to permit users to create form-understanding plug-ins 176. The method may present a user with a wizard-like series of windows that the user may interact with for the purpose of “training” the deep web miner 112, thereby providing the information necessary for a form-understanding plug-in to properly engage a specific web site's form processing engine 186, e.g., to map abstract query terms to the correct form inputs, recognize result anchors, and navigate to subsequent result pages.

The Add Site Plug-In component is schematically divided into steps that allow user interaction 302 and corresponding system operations 304 to process the user interaction 302. The Add Site Plug-In component may prompt the user to specify a form of interest at 306. In this regard, the user may identify the form by identifying a site URL, a search form within that web site, or any other information necessary to identify the form to the system by inputting appropriate information into a dialog box in a wizard screen. The form is obtained, e.g., retrieved and rendered at 308 and the user may optionally be able to confirm that the correct form is retrieved. In this regard, the retrieved form represents a query page for accessing the corresponding site's search engine.

Relevant form input(s) and example search term(s) may then be recognized or obtained. For example, the user may be prompted to identify characteristics of the form to the Add Site Plug-In component. In this regard, the user may initially identify form inputs at 310. The Add Site Plug-In component then learns the location of the form inputs from user action, e.g., by requiring the user to point and click on the query term dialog box of the corresponding form. The user is also prompted to enter example query term(s) at 312. Keeping with the above example of a wizard, a dialog box within the wizard may prompt the user to enter a simple query term. Alternatively, the Add Site Plug-In could otherwise obtain the form inputs and/or exemplary search terms without the assistance of a user, e.g., using a library of recognizers or other automated processes.

In response to obtaining this seed information, the Add Site Plug-In component simulates entry of the form to submit a query to the search engine based on the example query term(s). For example, the Add Site Plug-In component may access the Internet, e.g., using an appropriate HTTP transport 314 (which may be the same as transport 257 described with reference to FIG. 18A or a different instance of a transport), navigate to the web site/form of interest and submit the seed information obtained from the user based upon the learned location of the form inputs at 316.

The Add Site Plug-In component then retrieves and renders the results page at 318. For example, the Add Site Plug-In component may receive the query results returned in response to submitting the query form to the search engine. In this regard, the query results may include at least one page of addresses to locations on the network having content responsive to the submitted query.

As an illustrative example, the Add Site Plug-In component may enter a user-provided query term to the form, retrieve one page of search results and present the page of search results to the user. In this regard, the result page may not be “live”. Rather, the wizard may wrap the result page in its own processing screen to facilitate the learning necessary to navigate a “live” results page.

The Add Site Plug-In component then recognizes or obtains result anchors of interest within the query results and derives a pattern that distinguishes result anchors from non-result anchors. The Add Site Plug-In component may also recognize or obtain next page anchors of interest within the query results from the user and to derive a pattern that distinguishes next page anchors from other anchors. For example, the component may then allow the user to identify relevant result links at 320. By way of illustration, the user may identify all relevant search result anchors present on the returned page of results, such as by clicking on each anchor using a mouse. Because the result page is wrapped, the component can provide feedback to the user to confirm that the appropriate information has been identified.

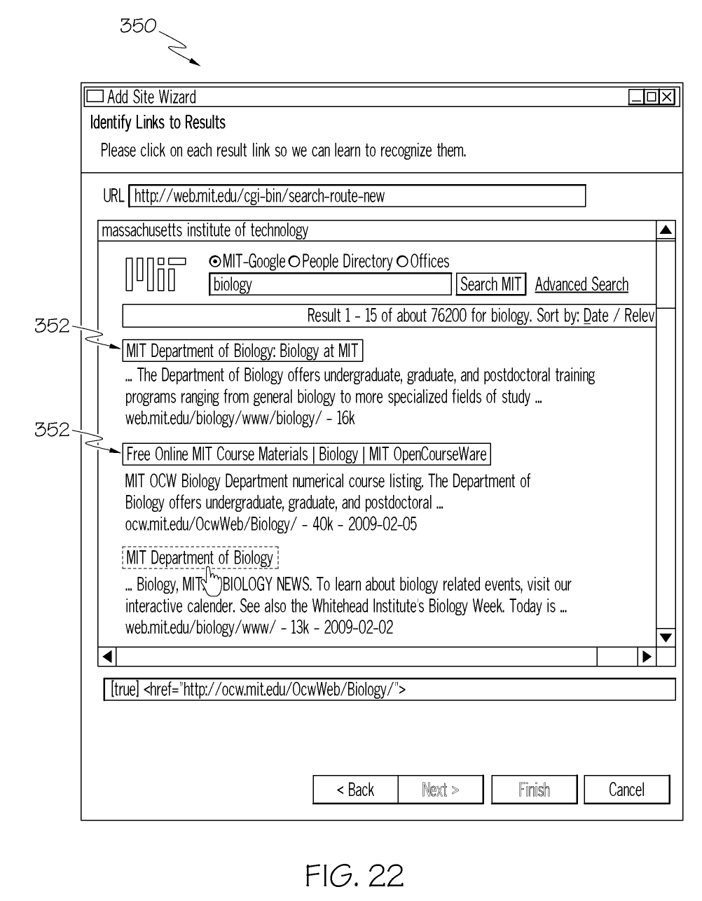

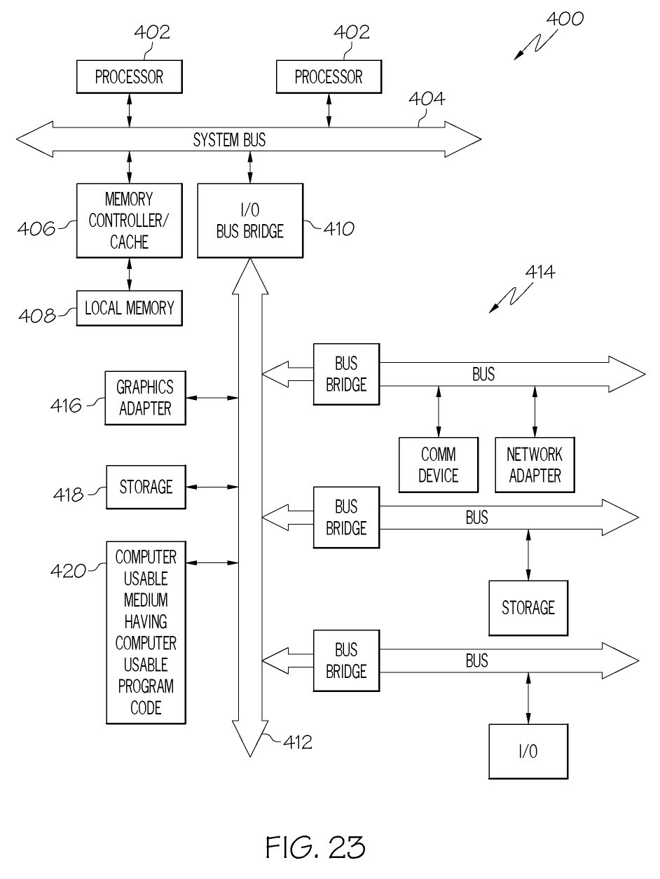

Referring briefly to FIG. 22, a screen shot 350 illustrates an exemplary implementation of the “obtain relevant results link” aspect of the Add Site Plug-In component, wherein a user may identify all relevant result links by clicking on each link that corresponds to a valid search result. To aid the user in completing the task, such user-identified result links may be visually distinguished 352 from irrelevant links, by color, indicia, etc. By way of illustration, and not by way of limitation, the background of relevant result anchors previously identified by a user may be highlighted in a color such as pink.

Referring back to FIG. 21, given a page of results and a list of the result anchors of interest, the Add Site Plug-In component learns result links at 322. For example, the Add Site Plug-In component may, according to various aspects of the present invention described more fully herein, derive a pattern that the deep web miner 112 can use in future interactions to recognize all search results that the search engine 186 produces for arbitrary query term(s), such that it can distinguish search result anchors contained in the result page from other irrelevant anchors that do not correspond with individual search results, e.g. links corresponding to advertisements, site-specific links, and so on. Additionally, the user may interactively provide an example of how to navigate to the next page of results at 324 where more than one page of results is available given the user provided seed information. The Add Site Plug-In component learns to recognize next page links at 326. For example, the Add Site Plug-In component may, according to various aspects of the present invention, derive a pattern that it can use to recognize anchors used to navigate to subsequent result pages, and to distinguish next page anchors contained in the result page from other irrelevant anchors that do not permit navigation to the next page of results.

The resulting information (web site, form elements, result anchor recognizer pattern, and next result anchor recognizer pattern) may be reviewed by the user at 328. If the user approves the resulting information, the resulting form-understanding plug-in is persisted for subsequent use by the deep web miner. For example, the form-understanding information may be saved at 330 as a form-understanding plug-in. For example, the Add Site Plug-In component may write a file in the local storage 122 that encapsulates a specific form-understanding plug-in implementation 176. Subsequent deep web mining tasks may then utilize the new form-understanding plug-in as described more fully herein.

Not all forms will utilize simple query terms. As such, according to various aspects of the present invention, the Add Site Plug-In component may use an iterative process to obtain alternate flows from the user. For example, if a form utilizes one or more complex modes, such as phrase, exclusionary terms, etc., the Add Site Plug-In component may prompt the user to enter each mode so that the appropriate information can be learned.

According to aspects of the invention, an Add Site Plug-In implementation may utilize a plurality of methods to attempt to “learn” (i.e. derive an effective pattern for) a result link recognizer and a next page link recognizer.

For example, to derive a pattern to distinguish anchors of interest from others, the Add Site Plug-In component may recognize or obtain anchors of interest, e.g., from the user and define a space of web page features to explore. The Add Site Plug-In component may further generate a series of one or more pattern instances within the web page feature space based on the anchors of interest and iteratively search through the series of pattern instances, e.g., from more general patterns to more specific patterns, to determine if the pattern matches one or more anchors present. The Add Site Plug-In component may accept a pattern if it matches only in the anchors of interest and does not match any other anchors.

An exemplary implementation may apply a heuristic approach of deriving a pattern given examples of valid result anchors. For example, a heuristic approach may involve searching through a space of HTML features present within and/or nearby the result link anchors that may possibly distinguish result anchors from non-result anchors. Categories of such HTML features may be explicitly enumerated in advance within the Add Site Plug-In component, from which specific patterns to test may be derived based on the result anchors present in the example query results.

The search through patterns may proceed iteratively, testing more general HTML features first, i.e., those having the broadest applicability, followed by more specific HTML features, i.e., those expected to be more sensitive to changes a web site may one day make in the form of its result pages. The search through patterns terminates when an effective pattern within the result page HTML is found that can correctly distinguish the result anchors from the non-result anchors, unless no such pattern can be found, which may result in a failure to construct a form-understanding plug-in.

As yet another illustrative example, an additional method for creating form-understanding plug-ins 176 may include providing a component to enable a user to create form-understanding plug-ins, such as by writing custom software or otherwise building the form-understanding plug-ins utilizing a library of routines for specifying the information needed to support deep web mining operations with a specific site's form processing engine 186. In this regard, the library of routines may enable a user to build a customized form-understanding plug-in by enabling the user to identify a web site, relevant form inputs and submission requirement(s) and patterns to distinguish result anchors and next page anchors from other anchors. For example, the information specified may include parameters such as site URLs; relevant form inputs and means of submission; and patterns that may distinguish result anchors from non-result anchors, and that may distinguish next page anchors from other anchors.

According to still further aspects of the present invention, some or all of the above-described user interaction in building a form-understanding plug-in may be replaced or otherwise implemented by an automated process. For example, the Add Site Plug-In component may obtain or identify a web site of interest, recognize or otherwise obtain relevant form input(s), generate or otherwise obtain example search term(s), recognize or otherwise obtain result anchors of interest within the query results, and/or recognize or otherwise obtain next page anchors of interest within the query results, etc., in an automated process.

Still further, the user input may be relegated to an approval mechanism. For example, the Add Site Plug-In component may obtain or identify a web site of interest, but prompt the user to confirm the action. Similarly, the Add Site Plug-In component may recognize or otherwise obtain relevant form input(s), generate or otherwise obtain example search term(s), recognize or otherwise obtain result anchors of interest within the query results, and/or recognize or otherwise obtain next page anchors of interest within the query results, etc., in an automated process, then subsequently prompt the user to confirm each action before saving the results and/or moving on to the next process.

As an example, rather than absolutely requiring the user to provide interaction, such as by providing an exemplary search term, the Add Site Plug-In component may use some general term or otherwise selected term that most search engines would respond to, or iteratively try a somewhat meaningful set of terms. As yet another example, the Add Site Plug-In component may automatically evaluate a library of effective next-page recognizers to find the next page anchors, etc.

Referring to FIG. 23, a block diagram of a data processing system is depicted in accordance with the present invention. Data processing system 400, such as one of the processing devices 102 described with reference to FIG. 1, may comprise one or more processors 402 connected to system bus 404. Also connected to system bus 404 is memory controller/cache 406, which provides an interface to local memory 408. An I/O bus bridge 410 is connected to the system bus 404 and provides an interface to an I/O bus 412. The I/O bus may be utilized to support one or more busses and corresponding devices 414, such as bus bridges, input output devices (I/O devices), storage, network adapters, etc. Network adapters may also be coupled to the system to enable the data processing system to become coupled to other data processing systems or remote printers or storage devices through intervening private or public networks.

Also connected to the I/O bus may be devices such as a graphics adapter 416, storage 418 and a computer usable storage medium 420 having computer usable program code embodied therewith. The computer usable program code may execute any aspect of the present invention, for example, to implement any aspect of any of the methods and/or system components illustrated in FIGS. 1-22. Moreover, the computer usable program code may be utilized to implement any other processes that are used to perform deep web searching, mining, etc., as set out further herein.

The various aspects of the present invention may be embodied as systems, computer-implemented methods and computer program products. Also, various aspects of the present invention may take the form of an embodiment combining software and hardware, wherein the embodiment or aspects thereof may be generally referred to as a “component” or “system.” Furthermore, the various aspects of the present invention may take the form of a computer program product on a computer usable storage medium having computer-usable program code embodied in the medium or a computer program product accessible from a computer-usable or computer-readable medium providing program code for use by or in connection with a computer or any instruction execution system.

The software aspects of the present invention may be stored, implemented and/or distributed on any suitable computer usable or computer readable medium(s). For the purposes of this description, a computer-usable or computer readable medium can be any apparatus that can contain, store, communicate, propagate, or transport the program for use by or in connection with the instruction execution system, apparatus, or device. The computer program product aspects of the present invention may have computer usable or computer readable program code portions thereof, which are stored together or distributed, either spatially or temporally across one or more devices. The computer-usable or computer-readable medium may also comprise a computer network itself as the computer program product moves from buffer to buffer propagating through the network. As such, any physical memory associated with part of a network or network component can constitute a computer readable medium.

The program code may execute entirely on a single processing device, partly on one or more different processing devices, as a stand-alone software package or as part of a larger system, partly on a local processing device and partly on a remote processing device or entirely on the remote processing device. In the latter scenario, the remote processing device may be connected to the local processing device through a network such as a local area network (LAN) or a wide area network (WAN), or the connection may be made to an external processing device, for example, through the Internet using an Internet Service Provider.

The present invention is described with reference to flowchart illustrations and/or block diagrams of methods, apparatus systems and computer program products comprising a computer usable medium having computer usable program code embodied therewith, according to embodiments of the invention. It will be understood that each block of the flowchart illustrations and/or block diagrams, and combinations of blocks in the flowchart illustrations and/or block diagrams may be implemented by system components or computer usable code that defines computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer usable code may also be stored in a computer-readable memory that can direct a computer or other programmable data processing apparatus to function in a particular manner, such that the instructions stored in the computer usable medium, such as a computer-readable memory, produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Once a computer is programmed to implement the various aspects of the present invention, including the methods of use as set out herein, such computer in effect, becomes a special purpose computer particular to the methods and program structures of this invention. The techniques necessary for this are well known to those skilled in the art of computer systems.

The flowchart and block diagrams in the Figures illustrate the architecture, functionality, and operation of possible implementations of systems, methods and computer program products according to various embodiments of the present invention. In this regard, one or more blocks in the flowchart or block diagrams may represent a component, segment, or portion of code, which comprises one or more executable instructions for implementing the specified logical function(s). In some alternative implementations, the functions noted in the blocks may occur out of the order noted in the figures. For example, two blocks shown in succession may, in fact, be executed substantially concurrently or in the reverse order.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention.

Having thus described the invention of the present application in detail and by reference to embodiments thereof, it will be apparent that modifications and variations are possible without departing from the scope of the invention defined in the appended claims.

What is claimed is:

1. A computer program product to performing deep web mining operations comprising:
a computer usable medium having computer usable program code embodied therewith, the computer usable program code comprising:
computer usable program code configured to define a new task corresponding to a concept space associated with a topic of interest to a user;
computer usable program code configured to obtain seed information with regard to the concept space including identifying at least one of an on-line form and at least one search term;
computer usable program code configured to create at least one deep mining thread associated with the defined new task, wherein the deep web mining thread performs a mining process including:
computer usable program code configured to define a plurality of content-service threads and crawler threads;
computer usable program code configured to generate at least one query derived from keyword information within the corresponding task and/or terms obtained from analysis of crawled content;
computer usable program code configured to queue the generated queries;
computer usable program code configured to declare a specific implementation of an abstract forms-based query service in a corresponding content-service thread that executes a deep mining process by matching an identified on-line form to a corresponding form-understanding plug-in that understands the format of the on-line form, wherein the selected form-understanding plug-in simulates the submission of a query and identifies relevant result addresses;
computer usable program code configured to queue query result addresses in a crawler queue;
computer usable program code configured to asynchronously service each result address by a corresponding crawler thread that obtains content and/or metadata that is cached in a local storage medium;
computer usable program code configured to process the content of the returned results; and
computer usable program code configured to update a display with a listing of the mined results, wherein the user may browse a local navigable copy of the crawled results in isolation by selecting a navigable entry of the listing.

2. The computer program product according to claim 1, wherein the computer usable program code configured to process the content of the returned results comprises:
computer usable program code configured to utilize a plurality of processors, each processor associated with a different returned file type.

3. The computer program product according to claim 1, wherein the computer usable program code configured to process the content of the returned results further comprises:
computer usable program code configured to identify the text content of returned results;
computer usable program code configured to perform a linguistic organization of the identified text;
computer usable program code configured to identify new terms associated with the corresponding concept space; and
computer usable program code configured to iteratively repeat the mining process until a predetermined stopping event is detected.

4. The computer program product according to claim 1, further comprising:
computer usable program code configured to collapse the multiple crawler threads to a single thread after data retrieval is complete.

5. The computer program product according to claim 1, further comprising:
computer usable program code configured to identify keyword generation parameters to control the manner in which query terms are generated as a result of analyzing crawled content.

6. The computer program product according to claim 1, further comprising:
computer usable program code configured to set user parameters regarding cookie privacy policies used when mining content associated with the corresponding task.

7. The computer program product according to claim 1, further comprising:
computer usable program code that allows a user to build a form-understanding plug-in that is usable by the computer usable program code configured to declare a specific implementation of an abstract forms-based query service in a corresponding content-service thread, comprising:
computer usable program code configured to obtain a web site of interest;
computer usable program code configured to retrieve a query page having a form for accessing the site's search engine;
computer usable program code configured to recognize or obtain relevant form input(s);
computer usable program code configured to generate or obtain example search term(s);
computer usable program code configured to simulate entry of the form to submit a query to the search engine based on the example query term(s);
computer usable program code configured to receive query results returned in response to submitting the query form to the search engine, the query results comprising at least one page of addresses to locations on the network having content responsive to the submitted query;
computer usable program code configured to recognize or obtain result anchors of interest within the query results;
computer usable program code configured to derive a pattern that distinguishes result anchors from non-result anchors;
computer usable program code configured to recognize or obtain next page anchors of interest within the query results;
computer usable program code configured to derive a pattern that distinguishes next page anchors from other anchors; and
computer usable program code configured for persisting the resulting form-understanding plug-in for subsequent use by the deep web miner.

8. The computer program product according to claim 7, wherein the computer usable program code configured to derive a pattern to distinguish anchors of interest from others comprises:
computer usable program code configured to recognize or obtain anchors of interest;
computer usable program code configured to define a space of web page features to explore;
computer usable program code configured to generate a series of one or more pattern instances within the web page feature space based on the anchors of interest;
computer usable program code configured to iteratively search through the series of pattern instances to determine if the pattern matches one or more anchors present; and
computer usable program code configured to accept a pattern if it matches only in the anchors of interest and does not match any other anchors.

9. The computer program product according to claim 8, wherein the computer usable program code configured to iteratively search through a series of pattern instances in an web page feature space proceeds from more general patterns to more specific patterns.

10. The computer program product according to claim 1, further comprising:
computer usable program code configured to enable a user to create deep web mining form-understanding plug-ins comprising:
computer usable program code configured to provide a library of routines for specifying the information needed to support deep web mining operations with a specific site's form processing engine, the library of routines enabling a user to build a form-understanding plug-in by identifying:
a web site;
relevant form inputs and submission requirement;
patterns to distinguish result anchors and next page anchors from other anchors.

11. A method of extracting information from a network comprising:
executing a user interface on a computer for obtaining seed information from a user, where the seed information provides sufficient information to define a concept of interest to the user;
identifying a search engine to utilize for performing deep web mining;
mapping the seed information provided by the user to query terms suitable for use with the identified search engine;
performing an iterative mining process until a stopping event is detected by:
retrieving a query page having a form for accessing the search engine;
simulating entry of the form to submit a query to the search engine based at least in part, upon the derived query terms;
receiving query results returned in response to submitting the query form to the search engine, the query results comprising at least one page of addresses to locations on the network having content responsive to the submitted query;
identifying addresses of interest from the query results for further processing;
crawling the network to obtain content from the identified addresses of interest;
building a local, navigable copy of the content obtained from crawling the network in a local storage device such that links within the content are limited to the local copy itself and do not function if the link contents were not captured by the corresponding mining process;
analyzing the resulting content returned from crawling the network generating at least one new content based query term based upon analyzing the search results;
updating the query terms based upon at least one new content-based query term;
dynamically conveying the results of processing to the user such that the user can interact with a dynamically changing local navigable environment while the mining process is iterating; and
dynamically reconfiguring the iterative mining process based upon user interaction, while the mining process is iterating.

12. The method of claim 11, wherein obtaining seed information comprises:
obtaining seed information from the user that defines at least one of a query term pertaining to the concept of interest and a name or address of the identified search engine.

13. The method of claim 11, further comprising:
defining the stopping event as a user imposed link exploration restraint based upon at least one of a total number of links, a link depth or a relevance of search results; and
overriding user defined depth constraints if query constraints are satisfied.

14. The method of claim 11, wherein identifying addresses of interest from the query results for further processing comprises:
distinguishing relevant result addresses from non-result addresses present in query result pages; and
constraining the addresses of interest to a super-domain of the search engine.

15. The method according to claim 11, wherein crawling the network to obtain content from the identified addresses of interest comprises:
constraining crawled pages to at least one of a domain of the search engine, a super-domain of the search engine, the domain of corresponding results pages or any number of segments of the domain of the corresponding results pages; and
performing link exploration by identifying addresses contained in obtained documents including HTML and non-HTML documents.

16. The method according to claim 11, further comprising:
maintaining a plurality of tasks where each task corresponds to a search implemented in response to a user initiated search request that can be saved, re-started or re-initialized; and
creating a plurality of crawler and content service threads for a corresponding task, wherein each thread maintains its own cookie space for storing cookies of visited network locations that utilize cookies.

17. The method according to claim 11, wherein generating at least one new content based query term based upon analyzing the search results comprises at least one of:
generating a paired query by narrowing an existing query with at least one additional conjunctive term that is determined to be weakly correlated with exiting primary terms and allowing the user to control the breadth of a mining process by controlling how closely concepts in the paired query must relate to a corresponding primary concept; and
generating a chained query by replacing a primary query with alternative terms that have been determined to by strongly correlated with all primary terms.

18. The method according to claim 11, wherein simulating entry of the form to submit a query to the search engine based at least in part, upon the derived query terms comprises:
matching an identified on-line form to a corresponding form-understanding plug-in that understands the format of the on-line form, wherein the selected form-understanding plug-in simulates the submission of a query and identifies relevant result addresses;

19. The method according to according to claim 18, further comprising enabling a user to build a form-understanding plug-in comprising:
obtaining a web site of interest;
retrieving a query page having a form for accessing the site's search engine;
recognizing or obtaining relevant form input(s);
generating or obtaining example search term(s);
simulating entry of the form to submit a query to the search engine based on the example query term(s);
receiving query results returned in response to submitting the query form to the search engine, the query results comprising at least one page of addresses to locations on the network having content responsive to the submitted query;
recognizing or obtaining result anchors of interest within the query results;
deriving a pattern that distinguishes result anchors from non-result anchors;
recognizing or obtaining next page anchors of interest within the query results;
deriving a pattern that distinguishes next page anchors from other anchors; and
persisting the resulting form-understanding plug-in for subsequent use by the deep web miner.

20. The method according to according to claim 18, wherein deriving a pattern to distinguish anchors of interest from others comprises:
obtaining anchors of interest from the user;
defining a space of web page features to explore;
generating a series of one or more pattern instances within the web page feature space based on the anchors of interest;
iteratively searching through the series of pattern instances to determine if the pattern matches one or more anchors present by proceeding from more general patterns to more specific patterns; and
accepting a pattern if it matches only in the anchors of interest and does not match any other anchors.
